(19) United States
(12) Patent Application Publication
(10) Pub. No.: US 2025/0370224 A1
(43) Pub. Date: Dec. 4, 2025

(54) OPTICAL IMAGING SYSTEM

(71) Applicant: Samsung Electro-Mechanics Co., Ltd., Suwon-si (KR)

(72) Inventors: Yong Joo JO, Suwon-si (KR); Ji Su LEE, Suwon-si (KR)

(73) Assignee: Samsung Electro-Mechanics Co., Ltd., Suwon-si (KR)

(21) Appl. No.: 19/008,209

(22) Filed: Jan. 2, 2025

(30) Foreign Application Priority Data
Jun. 3, 2024 (KR) 10-2024-0072303

(51) Int. Cl. G02B 13/00; G02B 9/64

(52) U.S. Cl. CPC G02B 13/0045; G02B 9/64

(57) ABSTRACT

An optical imaging system is provided. The optical imaging system includes a first lens having positive refractive power, a second lens having negative refractive power, a third lens having positive refractive power, a fourth lens having negative refractive power, a fifth lens having refractive power, a sixth lens having positive refractive power and a seventh lens having negative refractive power, wherein the first lens to the seventh lens are disposed in order from an object side, wherein the first lens to the seventh lens include a cemented lens that is formed by bonding adjacent surfaces of two lenses, disposed adjacently, to each other, and wherein the two lenses that form the cemented lens have opposite refractive powers.

### CROSS-REFERENCE TO RELATED APPLICATIONS

This application claims the benefit under 35 USC § 119 (a) of Korean Patent Application No. 10-2024-0072303 filed on Jun. 3, 2024 in the Korean Intellectual Property Office, the entire disclosure of which is incorporated herein by reference for all purposes.

### BACKGROUND

### 1. Field

The following description relates to an optical imaging system.

### 2. Description of Related Art

Recently, the performance of cameras that are mounted on a mobile device has improved.

For example, a high-resolution image sensor has been implemented in cameras for mobile devices, and an optical system has also been developed accordingly.

Generally, as a size of an image sensor increases, a total optical length of an optical system has been increased. However, since it may be desirous that a mobile device have a slim size, development of an optical system which may address the issue of performance degradation due to slimming and may implement high resolution may be desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens having positive refractive power, a second lens having negative refractive power, a third lens having positive refractive power, a fourth lens having negative refractive power, a fifth lens having refractive power, a sixth lens having positive refractive power, and a seventh lens having negative refractive power, wherein the first lens to the seventh lens are disposed in order from an object side, wherein the first lens to the seventh lens include a cemented lens that is formed by bonding adjacent surfaces of two lenses, disposed adjacently, to each other, and wherein the two lenses that form the cemented lens have opposite refractive powers.

The first lens and the second lens or the second lens and the third lens may be provided as the cemented lens.

The cemented lens may satisfy a conditional expression: 0≤|fa/Va−fb/Vb|<2, where fa and Va are respectively a focal length and an Abbe number of a lens disposed on an object side among the lenses cemented to each other, and fb and Vb are respectively a focal length and an Abbe number of a lens disposed on an image side among the two lenses cemented to each other.

The third lens may have a convex object-side surface in a paraxial region.

The fourth lens may have a concave object-side surface in a paraxial region.

Both an object-side surface of the sixth lens and an image-side surface of the sixth lens may be convex in a paraxial region.

The seventh lens may have a convex object-side surface in a paraxial region.

A conditional expression: 1.0<TTL/f<1.3, may be satisfied, where TTL is a distance from an object-side surface of the first lens to an image plane on an optical axis, and f is a total focal length of the optical imaging system.

The fifth lens may have negative refractive power.

In a general aspect, an optical imaging system includes a first lens, a second lens, a third lens having positive refractive power, a fourth lens having negative refractive power and a convex object-side surface, a fifth lens having refractive power, a sixth lens having positive refractive power, and a seventh lens having negative refractive power, wherein the first lens to the seventh lens are disposed in order from an object side, wherein a conditional expression: 0.5<TTL/(2*IMG HT)<0.8, is satisfied, where TTL is a distance from an object-side surface of the first lens to an image plane on an optical axis, and IMG HT is half a diagonal length of the image plane.

A conditional expression: 5<|f5/f|<10, may be satisfied, where f5 is a focal length of the fifth lens, and f is a total focal length of the optical imaging system.

A conditional expression: 0.5<f6/f<3, may be satisfied, where f6 is a focal length of the sixth lens, and f is a total focal length of the optical imaging system.

A conditional expression: 1<f3/f<3, may be satisfied, where f3 is a focal length of the third lens, and f is a total focal length of the optical imaging system.

The third lens may have a convex object-side surface in a paraxial region.

An object-side surface of the second lens may be bonded to an image-side surface of the first lens, or an image-side surface of the second lens may be bonded to an object-side surface of the third lens.

The first lens may have positive refractive power, and the second lens has negative refractive power.

In a general aspect, an optical imaging system includes a first lens, a second lens, a third lens having positive refractive power, a fourth lens having negative refractive power and a convex object-side surface, a fifth lens having refractive power, a sixth lens having positive refractive power, and a seventh lens having negative refractive power, wherein the first lens to the seventh lens are disposed in order from an object side, wherein a conditional expression: −10<f4/f<−1, is satisfied, where f4 is a focal length of the fourth lens, and f is a total focal length of the optical imaging system.

Other features and aspects will be apparent from the following detailed description, the drawings, and the claims.

### BRIEF DESCRIPTION OF DRAWINGS

FIG. 1A is a configuration diagram illustrating an example optical imaging system, in accordance with a first embodiment.

FIG. 1B is a graph indicating aberration properties of the example optical imaging system illustrated in FIG. 1A.

FIG. 2A is a configuration diagram illustrating an example optical imaging system, in accordance with a second embodiment.

FIG. 2B is a graph indicating aberration properties of the example optical imaging system illustrated in FIG. 2A.

FIG. 3A is a configuration diagram illustrating an example optical imaging system, in accordance with a third embodiment.

FIG. 3B is a graph indicating aberration properties of the example optical imaging system illustrated in FIG. 3A.

FIG. 4A is a configuration diagram illustrating an example optical imaging system in accordance with a fourth embodiment.

FIG. 4B is a graph indicating aberration properties of the example optical imaging system illustrated in FIG. 4A.

FIG. 5A is a configuration diagram illustrating an example optical imaging system in accordance with a fifth embodiment.

FIG. 5B is a graph indicating aberration properties of the example optical imaging system illustrated in FIG. 5A.

FIG. 6A is a configuration diagram illustrating an example optical imaging system in accordance with a sixth embodiment.

FIG. 6B is a graph indicating aberration properties of the example optical imaging system illustrated in FIG. 6A.

FIG. 7A is a configuration diagram illustrating an example optical imaging system in accordance with a seventh embodiment.

FIG. 7B is a graph indicating aberration properties of the example optical imaging system illustrated in FIG. 7A.

FIG. 8A is a configuration diagram illustrating an example optical imaging system in accordance with an eighth embodiment.

FIG. 8B is a graph indicating aberration properties of the example optical imaging system illustrated in FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more embodiments may provide an optical imaging system having a slim size, which may obtain a high-resolution image.

In the drawings, a thickness, a size, and a shape of a lens may be exaggerated for ease of description, and a spherical or aspherical shape of a lens is merely an example and is not limited thereto.

In the embodiments, a first lens may indicate the lens closest to the object side, and a seventh lens may indicate the lens closest to the image sensor side (or image side).

Also, in each lens, the first surface may indicate the surface closest to the object side (or an object-side surface), and the second surface may indicate the surface closest to the image sensor side (or an image-side surface).

In the description related to the shape of a lens of the embodiments, a convex surface may indicate that a paraxial region (a narrow region in vicinity of an optical axis) portion of a lens surface may be convex, and a concave surface may indicate that a paraxial region portion of the lens surface may be concave. Accordingly, even when one surface of the lens is described as having a convex shape, an edge portion of the lens may be concave. Similarly, although one surface of a lens is described as having a concave shape, an edge portion of the lens may be convex.

In the embodiment, length-related parameters, including a unit of a radius of curvature, thickness, distance, and focal length of a lens may be in millimeters (mm), and a unit of the field of view may be in degrees (°).

The optical imaging system according to the embodiments may include seven lenses. For example, the optical imaging system may include a first lens, a second lens, a third lens, a fourth lens, a fifth lens, a sixth lens, and a seventh lens disposed in order from an object side.

However, the optical imaging system according to the embodiments may not include only seven lenses.

For example, the optical imaging system may further include an image sensor configured to convert an image of an incident subject into an electrical signal.

Also, for example, the optical imaging system may further include an infrared blocking filter (hereinafter, “filter”) configured to block infrared light among light incident to the image sensor. In an example, the filter may be disposed between the seventh lens and the image sensor.

Additionally, in an example, the optical imaging system may further include a stop configured to adjust the amount of light.

The optical imaging system according to the embodiments may include a cemented lens. For example, two lenses disposed adjacently to each other among the first to seventh lenses may be provided as a cemented lens.

Specifically, the cemented lens may be provided in a form in which an image-side surface of a lens disposed close to an object side and an object-side surface of a lens disposed close to an image side among the two lenses disposed adjacently to each other are bonded to each other. In this example, the two surfaces bonded to each other may be the same aspherical surface or the same spherical surface, preferably.

According to the embodiments, the two lenses disposed adjacently to each other, provided as the cemented lens, may be bonded through a bond. For example, a bond satisfying predetermined conditions of a refractive index and Abbe number may be used for lens bonding, and the bond may be applied between the two lenses disposed adjacently to each other with a thickness of approximately 1 μm to 50 μm.

According to the embodiments, in an example, the refractive powers of the two lenses disposed adjacently to each other, and provided as the cemented lens, may be opposite to each other. in a non-limited example, among the two lenses provided as a cemented lens, the lens disposed closer to an object side may have positive or negative refractive power, and the lens disposed closer to an image side may have negative or positive refractive power.

The optical imaging system according to the embodiments may include a lens that is formed of a plastic material. In a non-limited example, the entirety of the first to seventh lenses included in the optical imaging system may be formed of a plastic material.

Additionally, each lens may have different optical properties from the adjacently disposed lenses. For example, the adjacently disposed lenses may have different refractive indices and Abbe numbers.

The optical imaging system according to the embodiments may include an aspherical surface lens. That is, at least one surface of at least one of the first to seventh lenses included in the optical imaging system may be an aspherical surface. Preferably, at least one surface of each of the first to seventh lenses may be an aspherical surface.

In an example, the aspherical surface of each lens may be represented as Equation 1 below.

$$Z = \frac{\text{?}}{1 \text{?}} + AY \text{?} + BY \text{?} + CY \text{?} + DY \text{?} + EY \text{?} + FY \text{?} + GY \text{?} + HY \text{?} + JY \text{?} + LY \text{?} + MY \text{?} + NY \text{?} + OY \text{?} + PY \text{?} \qquad Equation 1$$

$$\text{?} \text{indicates text missing or illegible when filed}$$

In equation 1, c is the radius of curvature of the lens (reciprocal of a radius of curvature), K is a conic constant, Y is the distance from any point on the aspherical surface of the lens to the optical axis, A-H, J, and L-P is an aspherical constant, and Z (or SAG) may be the distance in the optical axis direction from any point on the aspherical surface of the lens to an apex of the aspherical surface.

An optical imaging system according to the embodiments may satisfy the conditional expressions as below:

$$0 \leq \vert fa / Va - fb / Vb \vert < 2 \qquad [ Conditional expression 1 ]$$

$$10 < Vc < 80 \qquad [ Conditional expression 2 ]$$

$$Nb < Nc < Na \qquad [ Conditional expression 3 ]$$

In [Conditional expression 1], fa and Va may be a focal length and Abbe number of a lens disposed on an object side among two lenses bonded to each other, respectively, and fb and Vb may be a focal length and Abbe number of a lens disposed on an image side among two lenses bonded to each other, respectively. Additionally, in [Conditional expression 2] and [Conditional expression 3], Vc may be an Abbe number of the bond, and Nc may be an refractive index of the bond.

[Conditional expression 1] to [Conditional expression 3] may be related to optical property conditions of the bond used in the cemented lens and lens bonding for chromatic aberration correction. Particularly, [Conditional expression 1] may be a Conditional expression related to dechromatization of the optical imaging system, and when the conditional expression range is satisfied, chromatic aberration may be less likely to occur.

Additionally, the optical imaging system according to the embodiments may satisfy at least one of the conditional expressions below:

$$0.5 < f 1 / f < 2 \qquad [ Conditional expression 4 ]$$

$$- 3 < f 2 / f < - 1 \qquad [ Conditional expression 5 ]$$

$$1 < f 3 / f < 3 \qquad [ Conditional expression 6 ]$$

$$- 10 < f 4 / f < - 1 \qquad [ Conditional expression 7 ]$$

$$1 < \vert f 5 / f \vert < 10 \qquad [ Conditional expression 8 ]$$

$$0.5 < f 6 / f < 3 \qquad [ Conditional expression 9 ]$$

$$- 1 < f 7 / f < 0 \qquad [ Conditional expression 10 ]$$

$$1. < TTL / f < 1.3 \qquad [ Conditional expression 11 ]$$

$$0 < BFL / f < 0.3 \qquad [ Conditional expression 12 ]$$

$$0.5 < TTL / ( 2 ⋆ IMG HT ) < 0.8 \qquad [ Conditional expression 13 ]$$

$$1 < f / EPD < 3 \qquad [ Conditional expression 14 ]$$

In [Conditional expression 4] to [Conditional expression 13], f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, TTL is the distance from an object-side surface of the first lens to an image plane on the optical axis, BFL is the distance from an image-side surface of the seventh lens to the image plane on the optical axis, IMG HT is half the diagonal length of the image plane (that is, 2*IMG HT is a diagonal length of the image plane), and EPD may be a diameter of the entrance pupil.

[Conditional expression 4] to [Conditional expression 9] may be a ratio of a focal length of each lens to a total focal length of the optical imaging system, and may be related to appropriate refractive power of each lens for aberration correction. Additionally, [Conditional expression 10] to [Conditional expression 12] may be related to miniaturization of the optical imaging system, and [Conditional expression 13] may be related to the brightness performance of the optical imaging system.

### First Embodiment

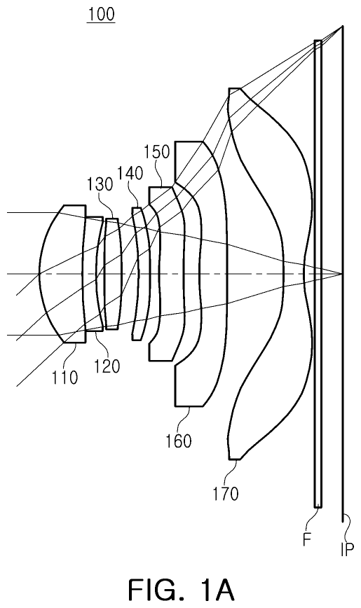

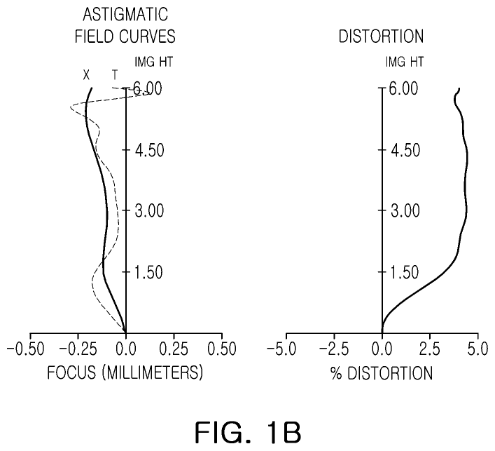

FIG. 1A is a configuration diagram illustrating an example optical imaging system in accordance with a first embodiment. FIG. 1B is a graph indicating aberration properties of the example optical imaging system illustrated in FIG. 1A.

The optical imaging system 100 according to the first embodiment may include a first lens 110, a second lens 120, a third lens 130, a fourth lens 140, a fifth lens 150, a sixth lens 160, and a seventh lens 170. A stop may be disposed between the second lens 120 and the third lens 130.

Additionally, the optical imaging system 100 may include a filter F and an imaging plane IP disposed on an image side of the seventh lens 170. The imaging plane IP may be a portion of an image sensor, in which light is received.

The optical imaging system 100 according to the first embodiment may have a total focal length of 5.90 mm, an IMG HT of 6.00 mm, and a FOV of 88.727) degrees (°.

Characteristics of each lens of the optical imaging system 100 in accordance with the first embodiment may have values as indicated in Table 1 below.

TABLE 1

| Surface | | Radius of | Thickness/ | Refractive | Abbe | Focal |
|---|---|---|---|---|---|---|
| No. | Note | curvature | distance | index | number | length |
| S1 | First | 2.583 | 0.996 | 1.519 | 59.98 | 6.06 |
| | lens | | | | | |
| S2 | | 12.294 | 0.000 | | | |
| S3 | Second | 12.294 | 0.312 | 1.710 | 19.73 | −15.45 |
| | lens | | | | | |
| S4 | | 5.769 | 0.198 | | | |
| S5 | Third | 16.492 | 0.397 | 1.587 | 61.47 | 13.74 |
| | lens | | | | | |
| S6 | | −15.756 | 0.391 | | | |
| S7 | Fourth | −10.993 | 0.263 | 1.686 | 31.41 | −23.38 |
| | lens | | | | | |
| S8 | | −34.749 | 0.214 | | | |
| S9 | Fifth | 6.610 | 0.564 | 1.635 | 23.96 | −55.34 |
| | lens | | | | | |
| S10 | | 5.386 | 0.361 | | | |
| S11 | Sixth | 6.090 | 0.653 | 1.567 | 37.40 | 7.90 |
| | lens | | | | | |
| S12 | | −16.652 | 1.288 | | | |
| S13 | Seventh | 45.780 | 0.470 | 1.535 | 55.74 | −4.67 |
| | lens | | | | | |
| S14 | | 2.371 | 0.254 | | | |
| S15 | Filter | Infinity | 0.140 | 1.517 | 64.20 | |
| S16 | | Infinity | 0.498 | | | |
| S17 | Imaging | Infinity | | | | |
| | plane | | | | | |

According to the first embodiment, the first lens 110 may have positive refractive power, a first surface (an object-side surface) of the first lens 110 may be convex in a paraxial region, and a second surface (an image-side surface) of the first lens 110 may be concave in a paraxial region.

The second lens 120 may have negative refractive power, a first surface (an object-side surface) of the second lens 120 may be convex in a paraxial region, and a second surface (an image-side surface) of the second lens 120 may be concave in a paraxial region.

The third lens 130 may have positive refractive power, and both a first surface (an object-side surface) of the third lens 130 and a second surface (an image-side surface) of the third lens 130 may be convex in a paraxial region.

The fourth lens 140 may have negative refractive power, a first surface (an object-side surface) of the fourth lens 140 may be concave in a paraxial region, and a second surface (an image-side surface) of the fourth lens 140 may be convex in a paraxial region.

The fifth lens 150 may have negative refractive power, a first surface (an object-side surface) of the fifth lens 150 may be convex in a paraxial region, and a second surface (an image-side surface) of the fifth lens 150 may be concave in a paraxial region.

The sixth lens 160 may have positive refractive power, a first surface (an object-side surface) of the sixth lens 160 may be convex in a paraxial region, and a second surface (an image-side surface) of the sixth lens 160 may be concave in a paraxial region.

The seventh lens 170 may have negative refractive power, a first surface (an object-side surface) of the seventh lens 170 may be convex in a paraxial region, and a second surface (an image-side surface) of the seventh lens 170 may be concave in a paraxial region.

According to the first embodiment, the first lens 110 and the second lens 120 may be a cemented lens.

For example, a second surface (an image-side surface) of the first lens 110 and a first surface (an object-side surface) of the second lens 120 bonded to a second surface (an image-side surface) of the first lens 110 may be spherical.

According to the first embodiment, at least one surface of each of the first to seventh lenses 110-170 may be aspherical.

Aspherical constants of each lens of the optical imaging system 100 according to the first embodiment may have values as indicated in Table 2 below.

TABLE 2

| | S1 | S2 | S3 | S4 | S5 | S6 | S7 |
|---|---|---|---|---|---|---|---|
| K | −1.565 | 0.000 | 0.000 | 11.666 | 42.975 | 98.981 | 23.677 |
| A | 3.391E−02 | 0.000E+00 | 0.000E+00 | 5.631E−02 | −5.227E−02 | −4.817E−03 | 6.535E−02 |
| B | −1.748E−01 | 0.000E+00 | 0.000E+00 | −7.024E−01 | 4.985E−01 | −1.011E−02 | −7.110E−01 |
| C | 6.449E−01 | 0.000E+00 | 0.000E+00 | 4.583E+00 | −3.318E+00 | −1.663E−01 | 3.971E+00 |
| D | −1.446E+00 | 0.000E+00 | 0.000E+00 | −1.927E+01 | 1.409E+01 | 1.266E+00 | −1.406E+01 |
| E | 2.121E+00 | 0.000E+00 | 0.000E+00 | 5.533E+01 | −4.062E+01 | −4.245E+00 | 3.387E+01 |
| F | −2.132E+00 | 0.000E+00 | 0.000E+00 | −1.126E+02 | 8.235E+01 | 8.487E+00 | −5.782E+01 |
| G | 1.510E+00 | 0.000E+00 | 0.000E+00 | 1.659E+02 | −1.197E+02 | −1.112E+01 | 7.156E+01 |
| H | −7.650E−01 | 0.000E+00 | 0.000E+00 | −1.789E+02 | 1.259E+02 | 9.965E+00 | −6.484E+01 |
| J | 2.782E−01 | 0.000E+00 | 0.000E+00 | 1.409E+02 | −9.556E+01 | −6.216E+00 | 4.297E+01 |
| L | −7.198E−02 | 0.000E+00 | 0.000E+00 | −8.006E+01 | 5.178E+01 | 2.698E+00 | −2.055E+01 |
| M | 1.292E−02 | 0.000E+00 | 0.000E+00 | 3.188E+01 | −1.948E+01 | −8.001E−01 | 6.901E+00 |
| N | −1.527E−03 | 0.000E+00 | 0.000E+00 | −8.433E+00 | 4.829E+00 | 1.549E−01 | −1.541E+00 |
| O | 1.068E*04 | 0.000E+00 | 0.000E+00 | 1.328E+00 | −7.080E−01 | −1.771E−02 | 2.054E−01 |
| P | −3.347E−06 | 0.000E+00 | 0.000E+00 | −9.419E−02 | 4.645E−02 | 9.119E−04 | −1.235E−02 |
| | S8 | S9 | S10 | S11 | S12 | S13 | S14 |
| K | −79.606 | −27.387 | 3.615 | −1.757 | −10.927 | 98.573 | −10.449 |
| A | −6.495E−02 | −1.016E−01 | −1.070E−01 | −3.247E−02 | 1.992E−02 | −1.322E−01 | −5.115E−02 |
| B | 1.593E−01 | 1.281E−01 | 6.305E−02 | −2.392E−02 | −2.959E−02 | 5.613E−02 | 2.614E−02 |
| C | −5.323E−01 | −2.083E−01 | −2.210E−02 | 6.555E−02 | 3.904E−02 | −1.556E−02 | −1.085E−02 |
| D | 1.456E+00 | 3.653E−01 | −2.812E−02 | −7.510E−02 | −3.177E−02 | 2.885E−03 | 3.173E−03 |
| E | −2.853E+00 | −5.777E−01 | 5.345E−02 | 4.812E−02 | 1.618E−02 | −3.425E−04 | −6.412E−04 |
| F | 3.917E+00 | 6.955E−01 | −4.536E−02 | −1.915E−02 | −5.570E−03 | 2.501E−05 | 9.032E−05 |
| G | −3.803E+00 | −5.996E−01 | 2.453E−02 | 4.807E−03 | 1.361E−03 | −1.163E−06 | −8.996E−06 |
| H | 2.636E+00 | 3.646E−01 | −9.196E−03 | −7.039E−04 | −2.420E−04 | 6.889E−08 | 6.396E−07 |
| J | −1.308E+00 | −1.556E−01 | 2.456E−03 | 3.500E−05 | 3.153E−05 | −8.392E−09 | −3.251E−08 |
| L | 4.600E−01 | 4.613E−02 | −4.669E−04 | 7.197E−06 | −2.981E−06 | 7.807E−10 | 1.171E−09 |
| M | −1.119E−01 | −9.272E−03 | 6.166E−05 | −1.651E−06 | 1.990E−07 | −4.308E−11 | −2.912E−11 |
| N | 1.790E−02 | 1.202E−03 | −5.366E−06 | 1.532E−07 | −8.887E−09 | 1.394E−12 | 4.753E−13 |
| O | −1.692E−03 | −9.036E−05 | 2.761E−07 | −7.150E−09 | 2.379E−10 | −2.471E−14 | −4.575E−15 |
| P | 7.157E−05 | 2.988E−06 | −6.340E−09 | 1.374E−10 | −2.884E−12 | 1.864E−16 | 1.967E−17 |

### Second Embodiment

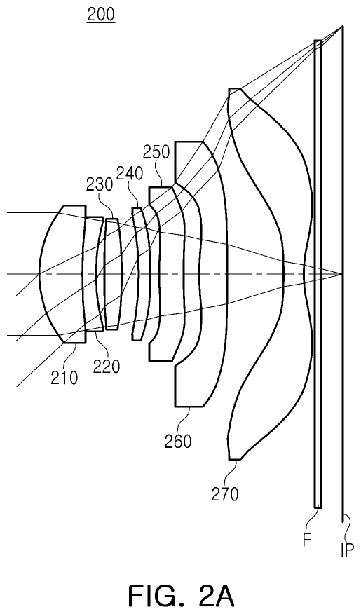

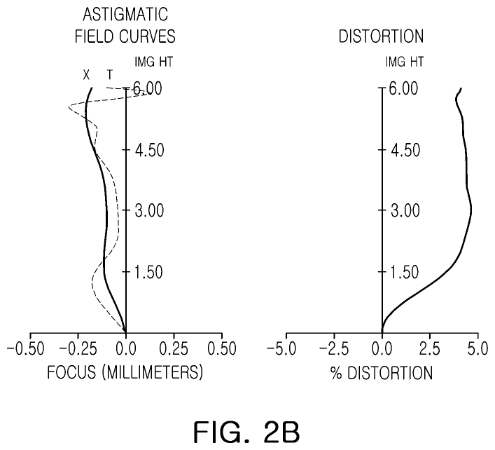

FIG. 2A is a configuration diagram illustrating an example optical imaging system according to a second embodiment. FIG. 2B is a graph indicating aberration properties of the example optical imaging system illustrated in FIG. 2A.

The optical imaging system 200 according to the second embodiment may include a first lens 210, a second lens 220, a third lens 230, a fourth lens 240, a fifth lens 250, a sixth lens 260, and a seventh lens 270. A stop may be disposed between the second lens 220 and the third lens 230.

Additionally, the optical imaging system 200 may include a filter F and an imaging plane IP disposed on an image side of the seventh lens 270. The imaging plane IP may be a portion of an image sensor, in which light is received.

The optical imaging system 200 according to the second embodiment may have a total focal length of 5.89 mm, an IMG HT of 6.00 mm, and a FOV of 88.80) degrees (°

Characteristics of each lens of the optical imaging system 200 according to the second embodiment may have values as indicated in Table 3 below.

TABLE 3

| Surface | | Radius of | Thickness/ | Refractive | Abbe | Focal |
|---|---|---|---|---|---|---|
| No. | Note | curvature | distance | index | number | length |
| S1 | First | 2.583 | 0.997 | 1.519 | 59.99 | 6.02 |
| | lens | | | | | |
| S2 | | 12.624 | 0.000 | | | |
| S3 | Second | 12.624 | 0.313 | 1.709 | 19.60 | −15.09 |
| | lens | | | | | |
| S4 | | 5.769 | 0.197 | | | |
| S5 | Third | 16.489 | 0.396 | 1.588 | 61.78 | 13.72 |
| | lens | | | | | |
| S6 | | −15.751 | 0.391 | | | |
| S7 | Fourth | −10.956 | 0.263 | 1.686 | 31.63 | −23.36 |
| | lens | | | | | |
| S8 | | −34.411 | 0.214 | | | |
| S9 | Fifth | 6.624 | 0.564 | 1.635 | 23.96 | −55.52 |
| | lens | | | | | |
| S10 | | 5.399 | 0.360 | | | |
| S11 | Sixth | 6.090 | 0.655 | 1.567 | 37.40 | 7.89 |
| | lens | | | | | |
| S12 | | −16.605 | 1.290 | | | |
| S13 | Seventh | 45.778 | 0.470 | 1.535 | 55.74 | −4.72 |
| | lens | | | | | |
| S14 | | 2.396 | 0.254 | | | |
| S15 | Filter | Infinity | 0.140 | 1.517 | 64.20 | |
| S16 | | Infinity | 0.503 | | | |
| S17 | Imaging | Infinity | | | | |
| | plane | | | | | |

According to the second embodiment, the first lens 210 may have positive refractive power, a first surface (an object-side surface) of the first lens 210 may be convex in a paraxial region, and a second surface (an image-side surface) of the first lens 210 may be concave in a paraxial region.

The second lens 220 may have negative refractive power, a first surface (an object-side surface) of the second lens 220 may be convex in a paraxial region, and a second surface (an image-side surface) of the second lens 220 may be concave in a paraxial region.

The third lens 230 may have positive refractive power, and both a first surface (an object-side surface) of the third lens 230 and a second surface (an image-side surface) of the third lens 230 may be convex in a paraxial region.

The fourth lens 240 may have negative refractive power, a first surface (an object-side surface) of the fourth lens 240 may be concave in a paraxial region, and a second surface (an image-side surface) of the fourth lens 240 may be convex in a paraxial region.

The fifth lens 250 may have negative refractive power, a first surface (an object-side surface) of the fifth lens 250 may be convex in a paraxial region, and a second surface (an image-side surface) of the fifth lens 250 may be concave in a paraxial region.

The sixth lens 260 may have positive refractive power, and both a first surface (an object-side surface) of the sixth lens 260 and a second surface (an image-side surface) of the sixth lens 260 may be convex in a paraxial region.

The seventh lens 270 may have negative refractive power, a first surface (an object-side surface) of the seventh lens 270 may be convex in a paraxial region, and a second surface (an image-side surface) of the seventh lens 270 may be concave in a paraxial region.

According to the second embodiment, the first lens 210 and the second lens 220 may be a cemented lens.

For example, a second surface (an image-side surface) of the first lens 210 and a first surface (an object-side surface) of the second lens 220 bonded to the second surface (an image-side surface) of the first lens 210 may be aspherical.

According to the second embodiment, at least one surface of each of the first to seventh lenses 210-270 may be aspherical.

Aspherical constants of each lens of the optical imaging system 200 according to the second embodiment may have values as indicated in Table 4 below.

TABLE 4

| | S1 | S2 | S3 | S4 | S5 | S6 | S7 |
|---|---|---|---|---|---|---|---|
| K | −1.563 | −0.309 | −0.309 | 11.660 | 43.108 | 98.897 | 23.650 |
| A | 3.435E−02 | 2.438E−02 | 2.438E−02 | 5.488E−02 | −5.401E−02 | −5.061E−03 | 6.640E−02 |
| B | −1.777E−01 | −6.073E−01 | −6.073E−01 | −6.620E−01 | 6.382E−01 | −1.284E−02 | −7.262E−01 |
| C | 6.517E−01 | 5.599E+00 | 5.599E+00 | 4.165E+00 | −3.653E+00 | −1.268E−01 | 4.055E+00 |
| D | −1.451E+00 | −2.788E+01 | −2.788E+01 | −1.700E+01 | 1.564E+01 | 1.050E+00 | −1.431E+01 |
| E | 2.119E+00 | 8.666E+01 | 8.666E+01 | 4.774E+01 | −4.510E+01 | −3.573E+00 | 3.428E+01 |
| F | −2.124E+00 | −1.808E+02 | −1.808E+02 | −9.569E+01 | 9.101E+01 | 7.146E+00 | −5.816E+01 |
| G | 1.502E+00 | 2.635E+02 | 2.635E+02 | 1.398E+02 | −1.313E+02 | −9.305E+00 | 7.155E+01 |
| H | −7.607E−01 | −2.741E+02 | −2.741E+02 | −1.501E+02 | 1.369E+02 | 8.242E+00 | −6.449E+01 |
| J | 2.767E−01 | 2.048E+02 | 2.048E+02 | 1.181E+02 | −1.030E+02 | −5.056E+00 | 4.255E+01 |
| L | −7.163E−0EEE2 | −1.091E+02 | −1.091E+02 | −6.717E+01 | 5.532E+01 | 2.146E+00 | −2.029E+01 |
| M | 1.286E−02 | 4.042E+01 | 4.042E+01 | 2.681E+01 | −2.065E+01 | −6.182E−01 | 6.796E+00 |
| N | −1.522E−03 | −9.906E+00 | −9.906E+00 | −7.107E+00 | 5.079E+00 | 1.155E−01 | −1.516E+00 |
| O | 1.066E−04 | 1.443E+00 | 1.443E+00 | 1.122E+00 | −7.395E−01 | −1.265E−02 | 2.019E−01 |
| P | −3.344E−06 | −9.454E−02 | −9.454E−02 | −7.976E−02 | 4.822E−02 | 6.203E−04 | −1.214E−02 |
| | S8 | S9 | S10 | S11 | S12 | S13 | S14 |
| K | −83.244 | −27.436 | 3.606 | −1.814 | −10.522 | 98.590 | −10.452 |
| A | −6.419E−02 | −1.019E−01 | −1.070E−01 | −3.230E−02 | 2.188E−02 | −1.311E−01 | −5.125E−02 |
| B | 1.499E−01 | 1.266E−01 | 6.278E−02 | −2.469E−02 | −3.391E−02 | 5.536E−02 | 2.594E−02 |
| C | 4.835E−01 | −1.990E−01 | −2.058E−02 | 6.536E−02 | 4.470E−02 | −1.546E−02 | −1.061E−02 |
| D | 1.317E+00 | 3.453E−01 | −3.057E−02 | −7.234E−02 | −3.588E−02 | 2.957E−03 | 3.061E−03 |
| E | −2.606E+00 | −5.546E−01 | 5.546E−02 | 4.436E−02 | 1.809E−02 | −3.783E−04 | −6.122E−04 |
| F | 3.612E+00 | 6.794E−01 | −4.60E−02 | −1.658E−02 | −6.181E−03 | 3.323E−05 | 8.560E−05 |
| G | −3.554E+00 | −5.927E−01 | 2.492E−02 | 3.717E−03 | 1.501E−03 | −2.339E−0 | −8.480E−06 |
| H | 2.486E+00 | 3.630E−01 | −9.317E−03 | 3.953E−04 | −2.653E−04 | 1.830E−07 | 6.006E−07 |
| J | −1.243E+00 | −1.556E−01 | 2.488E−03 | −2.536E−05 | 3.437E−05 | −1.613E−08 | −3.045E−08 |
| L | 4.399E−01 | 4.625E−02 | −4.736E−04 | 1.540E−05 | −3.231E−06 | 1.149E−0E9 | 1.094E−09 |
| M | −1.076E−01 | −9.309E−03 | 6.268E−05 | −2.414E−06 | 2.146E−07 | −5.518E−11 | −2.717E−11 |
| N | 1.729E−02 | 1.208E−03 | −5.469E−06 | 1.996E−07 | −9.538E−09 | 1.654E−12 | 4.427E−13 |
| O | −1.641E−03 | −9.086E−05 | 2.821E−07 | −8.812E−09 | 2.542E−10 | −2.80E−14 | −4.253E−15 |
| P | 6.962E−05 | 3.006E−06 | −6.494E−09 | 1.640E−10 | −3.069E−12 | 2.052E−16 | 1.824E−17 |

### Third Embodiment

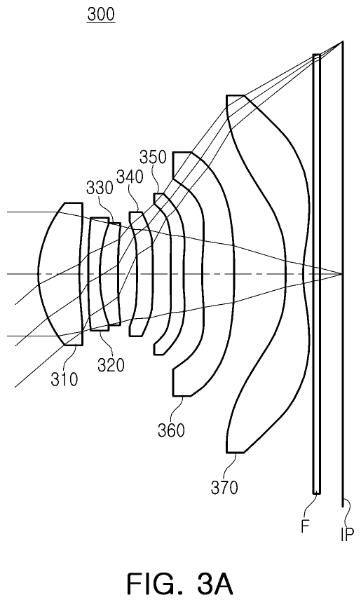

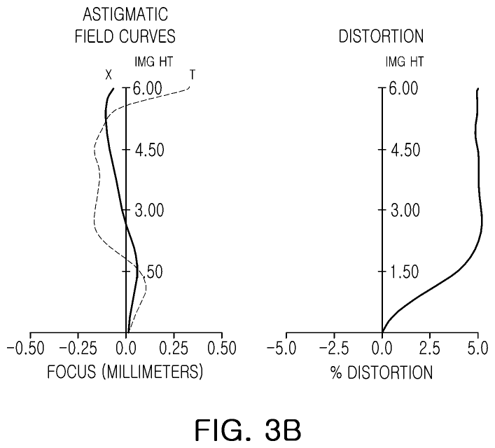

FIG. 3A is a configuration diagram illustrating an example optical imaging system according to a third embodiment. FIG. 3B is a graph indicating aberration properties of the example optical imaging system illustrated in FIG. 3A.

The optical imaging system 300 according to the third embodiment may include a first lens 310, a second lens 320, a third lens 330, a fourth lens 340, a fifth lens 350, a sixth lens 360, and a seventh lens 370. A stop may be disposed between the second lens 320 and the third lens 330.

Additionally, the optical imaging system 300 may include a filter F and an imaging plane IP disposed on an image side of the seventh lens 370. The imaging plane IP may be a portion of an image sensor, in which light is received.

The optical imaging system 300 according to the third embodiment may have a total focal length of 6.36 mm, an IMG HT of 6.00 mm, and a FOV of 84.00 degrees (°).

Characteristics of each lens of the optical imaging system 300 according to the third embodiment may have values as indicated in Table 5 below.

TABLE 5

| Surface | | Radius of | Thickness/ | Refractive | Abbe | Focal |
|---|---|---|---|---|---|---|
| No. | Note | curvature | distance | index | number | length |
| S1 | First | 2.670 | 1.018 | 1.565 | 59.95 | 6.19 |
| | lens | | | | | |
| S2 | | 9.623 | 0.212 | | | |
| S3 | Second | 20.672 | 0.283 | 1.710 | 27.38 | −7.32 |
| | lens | | | | | |
| S4 | | 4.157 | 0.000 | | | |
| S5 | Third | 4.157 | 0.454 | 1.590 | 72.91 | 9.08 |
| | lens | | | | | |
| S6 | | 17.614 | 0.461 | | | |
| S7 | Fourth | −25.211 | 0.388 | 1.702 | 24.47 | −60.12 |
| | lens | | | | | |
| S8 | | −62.065 | 0.425 | | | |
| S9 | Fifth | 7.818 | 0.336 | 1.679 | 32.61 | −53.15 |
| | lens | | | | | |
| S10 | | 6.322 | 0.452 | | | |
| S11 | Sixth | 7.993 | 0.782 | 1.567 | 37.40 | 7.94 |
| | lens | | | | | |
| S12 | | −10.082 | 1.270 | | | |
| S13 | Seventh | 55.434 | 0.433 | 1.535 | 55.74 | −5.90 |
| | lens | | | | | |
| S14 | | 2.988 | 0.258 | | | |
| S15 | Filter | Infinity | 0.142 | 1.517 | 64.20 | |
| S16 | | Infinity | 0.577 | | | |
| S17 | Imaging | Infinity | | | | |
| | plane | | | | | |

According to the third embodiment, the first lens 310 may have positive refractive power, a first surface (an object-side surface) of the first lens 310 may be convex in a paraxial region, and a second surface (an image-side surface) of the first lens 310 may be concave in a paraxial region.

The second lens 320 may have negative refractive power, a first surface (an object-side surface) of the second lens 320 may be convex in a paraxial region, and a second surface (an image-side surface) of the second lens 320 may be concave in a paraxial region.

The third lens 330 may have positive refractive power, a first surface (an object-side surface) of the third lens 330 may be convex in a paraxial region, and a second surface (an image-side surface) of the third lens 330 may be concave in a paraxial region.

The fourth lens 340 may have negative refractive power, a first surface (an object-side surface) of the fourth lens 340 may be concave in a paraxial region, and a second surface (an image-side surface) of the fourth lens 340 may be convex in a paraxial region.

The fifth lens 350 may have negative refractive power, a first surface (an object-side surface) of the fifth lens 350 may be convex in a paraxial region, and a second surface (an image-side surface) of the fifth lens 350 may be concave in a paraxial region.

The sixth lens 360 may have positive refractive power, and both a first surface (an object-side surface) of the sixth lens 360 and a second surface (an image-side surface) of the sixth lens 360 may be convex in a paraxial region.

The seventh lens 370 may have negative refractive power, a first surface (an object-side surface) of the seventh lens 370 may be convex in a paraxial region, and a second surface (an image-side surface) of the seventh lens 370 may be concave in a paraxial region.

According to the third embodiment, the second lens 320 and the third lens 330 may be a cemented lens.

For example, a second surface (an image-side surface) of the second lens 320 and a first surface (an object-side surface) of the third lens 330 bonded to the second surface (an image-side surface) of the second lens 320 may be spherical.

According to the third embodiment, at least one surface of each of the first to seventh lenses 310-370 may be aspherical.

Aspherical constants of each lens of the optical imaging system 300 according to the third embodiment may have values as indicated in Table 6 below.

TABLE 6

| | S1 | S2 | S3 | S4 | S5 | S6 | S7 |
|---|---|---|---|---|---|---|---|
| K | −1.817 | −36.789 | 19.210 | 0.000 | 0.000 | 98.996 | 98.908 |
| A | −9.858E−04 | −1.168E−02 | −5.437E−02 | 0.000E+00 | 0.000E+00 | −1.361E−001 | −3.361E−02 |
| B | 7.453E−02 | 5.635E−02 | 4.599E−01 | 0.000E+00 | 0.000E+00 | 1.285E+00 | −9.094E−02 |
| C | −2.414E−01 | −1.959E−01 | −2.336E+00 | 0.000E+00 | 0.000E+00 | −7.057E+00 | 8.139E−01 |
| D | 4.614E−01 | 4.255E−01 | 7.480E+00 | 0.000E+00 | 0.000E+00 | 2.454E+01 | −3.559E+00 |
| E | −5.765E−01 | −6.239E−01 | −1.601E+01 | 0.000E+00 | 0.000E+00 | −5.743E+01 | 9.639E+00 |
| F | 4.964E−01 | 6.376E−01 | 2.381E+01 | 0.000E+00 | 0.000E+00 | 9.398E+01 | −1.760E+01 |
| G | −3.033E−01 | −4.635E−01 | −2.524E+01 | 0.000E+00 | 0.000E+00 | −1.100E+02 | 2.250E+01 |
| H | 1.334E−01 | 2.424E−01 | 1.930E+01 | 0.000E+00 | 0.000E+00 | 9.326E+01 | −2.052E+01 |
| J | −4.227E−02 | −9.133E−02 | −1.066E+01 | 0.000E+00 | 0.000E+00 | −5.726E+01 | 1.341E+01 |
| L | 9.547E−03 | 2.456E−02 | 4.210E+00 | 0.000E+00 | 0.000E+00 | 2.520E+01 | −6.222E+00 |
| M | −1.495E−03 | −4.595E−03 | −1.158E+00 | 0.000E+00 | 0.000E+00 | −7.746E+00 | 1.997E+00 |
| N | 1.539E−04 | 5.682E−04 | 2.105E−01 | 0.000E+00 | 0.000E+00 | 1.578E+00 | −4.213E−01 |
| O | −9.330E−06 | −4.173E−05 | −2.272E−02 | 0.000E+00 | 0.000E+00 | −1.913E−01 | 5.245E−02 |
| P | 2.519E−07 | 1.378E−06 | 1.102E−03 | 0.000E+00 | 0.000E+00 | 1.045E−02 | −2.919E−03 |
| | S8 | S9 | S10 | S11 | S12 | S13 | S14 |
| K | −61.386 | −45.041 | 2.214 | 3.452 | 8.868 | 89.727 | −11.661 |
| A | −1.180E−02 | −8.224E−02 | −1.263E−01 | −3.572E−02 | −2.879E−03 | −1.259E−01 | −4.649E−02 |
| B | −1.539E−01 | 7.016E−02 | 1.649E−01 | 1.470E−02 | −1.231E−05 | 6.625E−02 | 2.221E−02 |
| C | 5.522E−01 | −2.602E−02 | −2.623E−01 | −1.990E−03 | 1.338E−02 | −2.708E−02 | −8.432E−03 |
| D | −1.163E+00 | −1.138E−01 | 3.241E−01 | −2.104E−03 | −1.471E−02 | 8.189E−03 | 2.245E−03 |
| E | 1.529E+00 | 2.635E−01 | −3.091E−01 | −3.728E−03 | 7.755E−03 | −1.761E−03 | −4.206E−04 |
| F | −1.250E+00 | −3.077E−01 | 2.238E−01 | 5.776E−03 | −2.536E−03 | 2.704E−04 | 5.633E−05 |
| G | 5.543E−01 | 2.355E−01 | −1.209E−01 | −3.460E−03 | 5.636E−04 | −3.005E−05 | −5.449E−06 |
| H | −1.408E−02 | −1.271E−01 | 4.804E−02 | 1.207E−03 | −8.862E−05 | 2.436E−06 | 3.822E−07 |
| J | −1.454E−01 | 4.945E−02 | −1.388E−02 | −2.723E−04 | 1.001E−05 | −1.441E−07 | −1.937E−08 |
| L | 9.669E−02 | −1.385E−02 | 2.864E−03 | 4.101E−05 | −8.111E−07 | 6.156E−09 | 6.998E−10 |
| M | −3.314E−02 | 2.724E−03 | −4.101E−04 | −4.104E−06 | 4.611E−08 | −1.849E−10 | −1.753E−11 |
| N | 6.660E−03 | −3.576E−04 | 3.858E−05 | 2.621E−07 | −1.751E−09 | 3.702E−12 | 2.889E−13 |
| O | −7.454E−04 | 2.809E−05 | −2.141E−06 | −9.675E−09 | 3.996E−11 | −4.438E−14 | −2.811E−15 |
| P | 3.605E−05 | −9.974E−07 | 5.304E−08 | 1.570E−10 | −4.147E−13 | 2.409E−16 | 1.223E−17 |

### Fourth Embodiment

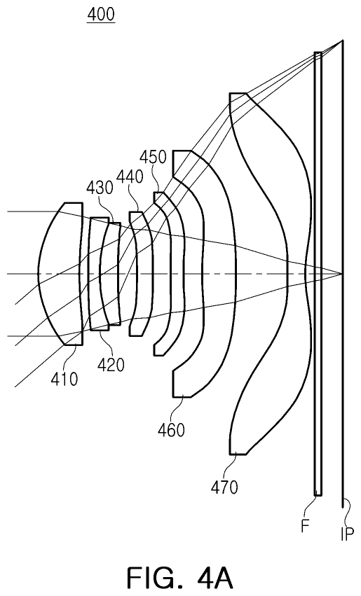

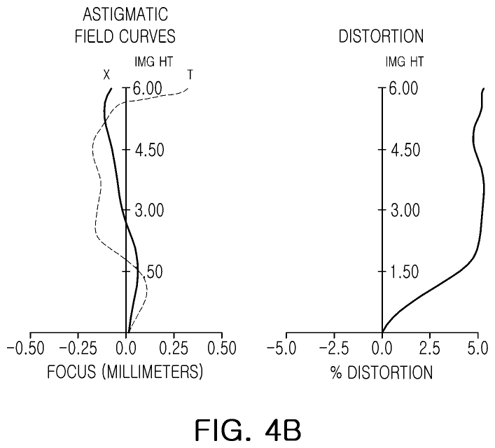

FIG. 4A is a configuration diagram illustrating an example optical imaging system according to a fourth embodiment. FIG. 4B is a graph indicating aberration properties of the example optical imaging system illustrated in FIG. 4A.

The optical imaging system 400 according to the fourth embodiment may include a first lens 410, a second lens 420, a third lens 430, a fourth lens 440, a fifth lens 450, a sixth lens 460, and a seventh lens 470. A stop may be disposed between the second lens 420 and the third lens 430.

Additionally, the optical imaging system 400 may include a filter F and an imaging plane IP disposed on an image side of the seventh lens 470. The imaging plane IP may be a portion of an image sensor, in which light is received.

The optical imaging system 400 according to the fourth embodiment may have a total focal length of 6.32 mm, an IMG HT of 6.00 mm, and a FOV of 84.20 degrees (°).

Characteristics of each lens of the optical imaging system 400 according to the fourth embodiment may have values as indicated in Table 7 below.

TABLE 7

| Surface | | Radius of | Thickness/ | Refractive | Abbe | Focal |
|---|---|---|---|---|---|---|
| No. | Note | curvature | distance | index | number | length |
| S1 | First | 2.670 | 1.020 | 1.568 | 56.55 | 6.16 |
| | lens | | | | | |
| S2 | | 9.584 | 0.211 | | | |
| S3 | Second | 20.428 | 0.282 | 1.707 | 24.55 | −7.05 |
| | lens | | | | | |
| S4 | | 4.017 | 0.000 | | | |
| S5 | Third | 4.017 | 0.452 | 1.590 | 55.55 | 8.67 |
| | lens | | | | | |
| S6 | | 17.585 | 0.463 | | | |
| S7 | Fourth | −25.349 | 0.391 | 1.701 | 26.92 | −60.12 |
| | lens | | | | | |
| S8 | | −63.224 | 0.424 | | | |
| S9 | Fifth | 7.852 | 0.333 | 1.676 | 33.04 | −54.13 |
| | lens | | | | | |
| S10 | | 6.361 | 0.454 | | | |
| S11 | Sixth | 7.989 | 0.813 | 1.567 | 37.40 | 7.95 |
| | lens | | | | | |
| S12 | | −10.113 | 1.274 | | | |
| S13 | Seventh | 55.651 | 0.417 | 1.535 | 55.74 | −5.82 |
| | lens | | | | | |
| S14 | | 2.952 | 0.258 | | | |
| S15 | Filter | Infinity | 0.142 | 1.517 | 64.20 | |
| S16 | | Infinity | 0.537 | | | |
| S17 | Imaging | Infinity | | | | |
| | plane | | | | | |

According to the fourth embodiment, the first lens 410 may have positive refractive power, a first surface (an object-side surface) of the first lens 410 may be convex in a paraxial region, and a second surface (an image-side surface) of the first lens 410 may be concave in a paraxial region.

The second lens 420 may have negative refractive power, a first surface (an object-side surface) of the second lens 420 may be convex in a paraxial region, and a second surface (an image-side surface) of the second lens 420 may be concave in a paraxial region.

The third lens 430 may have positive refractive power, a first surface (an object-side surface) of the third lens 430 may be convex in a paraxial region, and a second surface (an image-side surface) of the third lens 430 may be concave in a paraxial region.

The fourth lens 440 may have negative refractive power, a first surface (an object-side surface) of the fourth lens 440 may be concave in a paraxial region, and a second surface (an image-side surface) of the fourth lens 440 may be convex in a paraxial region.

The fifth lens 450 may have negative refractive power, a first surface (an object-side surface) of the fifth lens 450 may be convex in a paraxial region, and a second surface (an image-side surface) of the fifth lens 450 may be concave in a paraxial region.

The sixth lens 460 may have positive refractive power, and both a first surface (an object-side surface) of the sixth lens 460 and a second surface (an image-side surface) of the sixth lens 460 may be convex in a paraxial region.

The seventh lens 470 may have negative refractive power, a first surface (an object-side surface) of the seventh lens 470 may be convex in a paraxial region, and a second surface (an image-side surface) of the seventh lens 470 may be concave in a paraxial region.

According to the fourth embodiment, the second lens 420 and the third lens 430 may be a cemented lens.

For example, a second surface (an image-side surface) of the second lens 420 and a first surface (an object-side surface) of the third lens 430 bonded to the second surface (an image-side surface) of the second lens 420 may be aspherical.

According to the fourth embodiment, at least one surface of each of the first to seventh lenses 410-470 may be aspherical.

Aspherical constants of each lens of the optical imaging system 400 according to the fourth embodiment may have values as indicated in Table 8 below.

TABLE 8

| | S1 | S2 | S3 | S4 | S5 | S6 | S7 |
|---|---|---|---|---|---|---|---|
| K | −1.816 | −37.685 | 18.641 | 0.029 | 0.029 | 99.049 | 98.756 |
| A | −1.463E−03 | −1.154E−02 | −5.040E−02 | 1.163E−03 | 1.163E−03 | −1.333E−01 | −3.138E−02 |
| B | 7.826E−02 | 5.369E−02 | 4.084E−01 | −1.398E−02 | −1.398E−02 | 1.262E+00 | −1.239E−01 |
| C | −2.547E−01 | −1.790E−01 | −2.018E+00 | 9.181E−02 | 9.181E−02 | −6.961E+00 | 1.048E+00 |
| D | 4.879E−01 | 3.701E−01 | 6.334E+00 | −5.004E−01 | −5.004E−01 | 2.436E+01 | −4.527E+00 |
| E | −6.101E−01 | −5.157E−01 | −1.338E+01 | 2.070E+00 | 2.070E+00 | −5.744E+01 | 1.220E+01 |
| F | 5.249E−01 | 5.005E−01 | 1.975E+01 | −6.023E+00 | −6.023E+00 | 9.476E+01 | −2.215E+01 |
| G | −3.201E−01 | −3.454E−01 | −2.087E+01 | 1.222E+01 | 1.222E+01 | −1.119E+02 | 2.815E+01 |
| H | 1.403E−01 | 1.714E−01 | 1.596E+01 | −1.748E+01 | −1.748E+01 | 9.569E+01 | −2.549E+01 |
| J | −4.431E−02 | −6.123E−02 | −8.834E+00 | 1.774E+01 | 1.774E+01 | −5.929E+01 | 1.653E+01 |
| L | 9.962E−03 | 1.560E−02 | 3.502E+00 | −1.271E+01 | −1.271E+01 | 2.634E+01 | −7.610E+00 |
| M | −1.552E−03 | −2.764E−03 | 9.681E−01 | 6.294E+00 | 6.294E+00 | −8.168E+00 | 2.424E+00 |
| N | 1.588E−04 | 3.234E−04 | 1.770E−01 | −2.049E+00 | −2.049E+00 | 1.679E+00 | −5.076E−01 |
| O | −9.565E−06 | −2.245E−05 | −1.921E−02 | 3.947E−01 | 3.947E−01 | −2.053E−01 | 6.277E−02 |
| P | 2.561E−07 | 6.999E−07 | 9.369E−04 | −3.408E−02 | −3.408E−02 | 1.132E−02 | −3.471E−03 |
| | S8 | S9 | S10 | S11 | S12 | S13 | S14 |
| K | 15.276 | −45.111 | 2.395 | 3.600 | 8.916 | 89.258 | −11.221 |
| A | −1.054E−02 | −8.419E−02 | −1.289E−01 | −4.107E−02 | −2.815E−03 | −1.263E−01 | −4.952E−02 |
| B | −1.632E−01 | 8.463E−02 | 1.793E−01 | 3.237E−02 | 1.030E−03 | 6.761E−02 | 2.637E−02 |
| C | 5.749E−01 | −7.366E−02 | −2.970E−01 | −3.008E−02 | −1.184E−02 | −2.882E−02 | −1.070E−02 |
| D | −1.167E+00 | −2.294E−02 | 3.744E−01 | 2.527E−02 | −1.367E−02 | 9.140E−03 | 2.902E−03 |
| E | 1.429E+00 | 1.507E−01 | −3.568E−01 | −2.137E−02 | 7.333E−03 | −2.053E−03 | −5.380E−04 |
| F | −9.956E−01 | −2.103E−01 | 2.551E−01 | 1.361E−02 | −2.427E−03 | 3.275E−04 | 7.033E−05 |
| G | 2.214E−01 | 1.747E−01 | −1.354E−01 | −5.913E−03 | 5.459E−04 | −3.759E−05 | −6.618E−06 |
| H | 2.620E−01 | −9.898E−02 | 5.292E−02 | 1.756E−03 | −8.740E−05 | 3.135E−06 | 4.522E−07 |
| J | −2.993E−01 | 3.982E−02 | −1.507E−02 | −3.600E−04 | 9.993E−06 | −1.900E−07 | −2.239E−08 |
| L | 1.552E−01 | −1.143E−02 | 3.072E−03 | 5.093E−05 | −8.242E−07 | 8.281E−09 | 7.927E−10 |
| M | −4.818E−02 | 2.293E−03 | −4.356E−04 | −4.876E−06 | 4.778E−08 | −2.530E−10 | −1.952E−11 |
| N | 9.156E−03 | −3.059E−04 | 4.066E−05 | 3.015E−07 | −1.852E−09 | 5.138E−12 | 3.169E−13 |
| O | −9.872E−04 | 2.438E−05 | −2.242E−06 | −1.085E−08 | 4.317E−11 | −6.232E−14 | −3.046E−15 |
| P | 4.643E−05 | −8.767E−07 | 5.523E−08 | 1.727E−10 | −4.575E−13 | 3.414E−16 | 1.311E−17 |

### Fifth Embodiment

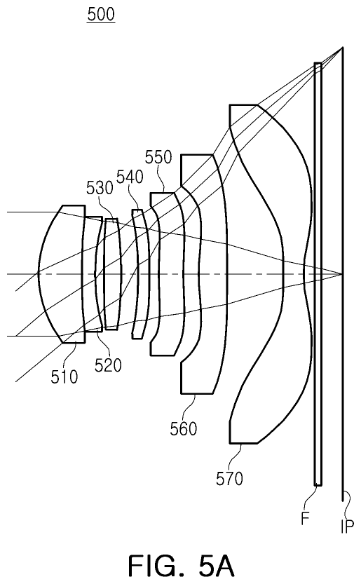

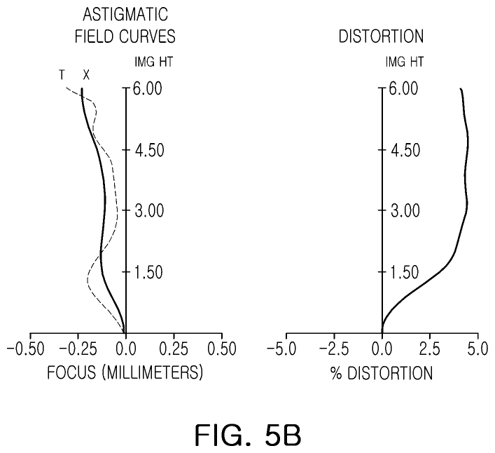

FIG. 5A is a configuration diagram illustrating an example optical imaging system according to a fifth embodiment. FIG. 5B is a graph indicating aberration properties of the example optical imaging system illustrated in FIG. 5A.

An optical imaging system 500 according to a fifth embodiment may include a first lens 510, a second lens 520, a third lens 530, a fourth lens 540, a fifth lens 550, a sixth lens 560, and a seventh lens 570. A stop may be disposed between the second lens 520 and the third lens 530.

Additionally, the optical imaging system 500 may include a filter F and an imaging plane IP disposed on an image side of the seventh lens 570. The imaging plane IP may be a portion of an image sensor, in which light is received.

A total focal length of the optical imaging system 500 according to a fifth embodiment may be 6.49 mm, an IMG HT may be 6.00 mm, and an FOV may be 83.20 degrees (°).

Characteristics of each lens of the optical imaging system 500 according to the fifth embodiment may have values as indicated in Table 9 below.

TABLE 9

| Surface | | Radius of | Thickness/ | Refractive | Abbe | Focal |
|---|---|---|---|---|---|---|
| No. | Note | curvature | distance | index | number | length |
| S1 | First | 2.841 | 1.096 | 1.519 | 59.98 | 6.67 |
| | lens | | | | | |
| S2 | | 13.523 | 0.000 | | | |
| S3 | Second | 13.523 | 0.343 | 1.710 | 19.73 | −16.99 |
| | lens | | | | | |
| S4 | | 6.345 | 0.217 | | | |
| S5 | Third | 18.141 | 0.437 | 1.587 | 61.47 | 15.11 |
| | lens | | | | | |
| S6 | | −17.332 | 0.430 | | | |
| S7 | Fourth | −12.092 | 0.289 | 1.686 | 31.41 | −25.71 |
| | lens | | | | | |
| S8 | | −38.224 | 0.235 | | | |
| S9 | Fifth | 7.271 | 0.620 | 1.635 | 23.96 | −60.87 |
| | lens | | | | | |
| S10 | | 5.925 | 0.397 | | | |
| S11 | Sixth | 6.699 | 0.718 | 1.567 | 37.40 | 8.69 |
| | lens | | | | | |
| S12 | | −18.318 | 1.417 | | | |
| S13 | Seventh | 50.358 | 0.517 | 1.535 | 55.74 | −5.14 |
| | lens | | | | | |
| S14 | | 2.608 | 0.280 | | | |
| S15 | Filter | Infinity | 0.154 | 1.517 | 64.20 | |
| S16 | | Infinity | 0.548 | | | |
| S17 | Imaging | Infinity | | | | |
| | plane | | | | | |

According to the fifth embodiment, the first lens 510 may have positive refractive power, a first surface (an object-side surface) of the first lens 510 may be convex in a paraxial region, and a second surface (an image-side surface) of the first lens 510 may be concave in a paraxial region.

The second lens 520 may have negative refractive power, a first surface (an object-side surface) of the second lens 520 may be convex in a paraxial region, and a second surface (an image-side surface) of the second lens 520 may be concave in a paraxial region.

The third lens 530 may have positive refractive power, and both a first surface (an object-side surface) of the third lens 530 and a second surface (an image-side surface) of the third lens 530 may be convex in a paraxial region.

The fourth lens 540 may have negative refractive power, a first surface (an object-side surface) of the fourth lens 540 may be concave in a paraxial region, and a second surface (an image-side surface) of the fourth lens 540 may be convex in a paraxial region.

The fifth lens 550 may have negative refractive power, a first surface (an object-side surface) of the fifth lens 550 may be convex in a paraxial region, and a second surface (an image-side surface) of the fifth lens 550 may be concave in a paraxial region.

The sixth lens 560 may have positive refractive power, and both a first surface (an object-side surface) of the sixth lens 560 and a second surface (an image-side surface) of the sixth lens 560 may be convex in a paraxial region.

The seventh lens 570 may have negative refractive power, and a first surface (an object-side surface) of the seventh lens 570 may be convex in a paraxial region, and a second surface (an image-side surface) of the seventh lens 570 may be concave in a paraxial region.

According to the fifth embodiment, the first lens 510 and the second lens 520 may be a cemented lens.

For example, a second surface (an image-side surface) of the first lens 510 and a first surface (an object-side surface) of the second lens 520 bonded to the second surface (an image-side surface) of the first lens 510 may be spherical.

According to the fifth embodiment, at least one surface of each of the first to seventh lenses 510-570 may be aspherical.

Aspherical constants of each lens of the optical imaging system 500 according to the fifth embodiment may have values as indicated in Table 10 below.

TABLE 10

| | S1 | S2 | S3 | S4 | S5 | S6 | S7 |
|---|---|---|---|---|---|---|---|
| K | −1.565 | 0.000 | 0.000 | 11.666 | 42.975 | 98.981 | 23.677 |
| A | 2.548E−02 | 0.000E+00 | 0.000E+00 | 4.231E−02 | −3.927E−02 | −3.619E−03 | 4.910E−02 |
| B | −1.085E−01 | 0.000E+00 | 0.000E+00 | −4.362E−01 | 3.095E−01 | −6.276E−03 | −4.415E−01 |
| C | 3.309E−01 | 0.000E+00 | 0.000E+00 | 2.352E+00 | −1.702E+00 | −8.532E−02 | 2.038E+00 |
| D | −6.130E−01 | 0.000E+00 | 0.000E+00 | −8.174E+00 | 5.975E+00 | 5.371E−01 | −5.964E+00 |
| E | 7.433E−01 | 0.000E+00 | 0.000E+00 | 1.939E+01 | −1.424E+01 | −1.488E+00 | 1.187E+01 |
| F | −6.175E−01 | 0.000E+00 | 0.000E+00 | −3.260E+01 | 2.385E+01 | 2.458E+00 | −1.675E+01 |
| G | 3.614E−01 | 0.000E+00 | 0.000E+00 | 3.971E+01 | −2.866E+01 | −2.662E+00 | 1.713E+01 |
| H | −1.514E−01 | 0.000E+00 | 0.000E+00 | −3.539E+01 | 2.490E+01 | 1.972E+00 | −1.283E+01 |
| J | 6.550E−02 | 0.000E+00 | 0.000E+00 | 2.304E+01 | −1.562E+01 | −1.016E+00 | 7.025E+00 |
| L | −9.727E−03 | 0.000E+00 | 0.000E+00 | −1.082E+01 | 6.997E+00 | 3.646E−01 | −2.777E+00 |
| M | 1.442E−03 | 0.000E+00 | 0.000E+00 | 3.561E+00 | −2.176E+00 | −8.935E−02 | 7.707E−01 |
| N | −1.409E−04 | 0.000E+00 | 0.000E+00 | −7.783E−01 | 4.457E−01 | 1.430E−02 | −1.423E−01 |
| O | 8.145E−06 | 0.000E+00 | 0.000E+00 | 1.013E−01 | −5.400E−02 | −1.351E−03 | 1.567E−02 |
| P | −2.110E−07 | 0.000E+00 | 0.000E+00 | −5.938E−03 | 2.928E−03 | 5.748E−05 | −7.787E−04 |
| | S8 | S9 | S10 | S11 | S12 | S13 | S14 |
| K | −79.606 | −27.387 | 3.615 | −1.757 | −10.927 | 98.573 | −10.449 |
| A | −4.880E−02 | −7.635E−02 | −8.042E−02 | −2.440E−02 | 1.497E−02 | −9.934E−02 | −3.843E−02 |
| B | 9.889E−02 | 7.955E−02 | 3.915E−02 | −1.485E−02 | −1.837E−02 | 3.485E−02 | 1.623E−02 |
| C | −2.732E−01 | −1.069E−01 | −1.134E−02 | 3.364E−02 | 2.004E−02 | −7.983E−03 | −5.569E−03 |
| D | 6.174E−01 | 1.549E−01 | −1.193E−02 | −3.185E−02 | −1.348E−02 | 1.224E−03 | 1.346E−03 |
| E | −1.000E+00 | −2.025E−01 | 1.873E−02 | 1.687E−02 | 5.672E−03 | −1.201E−04 | −2.247E−04 |
| F | 1.135E+00 | 2.015E−01 | −1.314E−02 | −5.546E−03 | −1.613E−03 | 7.244E−06 | 2.616E−05 |
| G | −9.104E−01 | −1.435E−01 | 5.871E−03 | 1.151E−03 | 3.258E−04 | −2.784E−07 | −2.153E−06 |
| H | 5.216E−01 | 7.213E−02 | −1.819E−03 | −1.393E−04 | −4.789E−05 | 1.363E−08 | 1.265E−07 |
| J | −2.138E−01 | −2.544E−02 | 4.016E−04 | 5.723E−06 | 5.156E−06 | −1.372E−09 | −5.316E−09 |
| L | 6.216E−02 | 6.234E−03 | −6.309E−05 | 9.725E−07 | −4.028E−07 | 1.055E−10 | 1.582E−10 |
| M | −1.250E−02 | −1.035E−03 | 6.886E−06 | −1.844E−07 | 2.222E−08 | −4.811E−12 | −3.252E−12 |
| N | 1.653E−03 | 1.109E−04 | −4.953E−07 | 1.414E−08 | −8.202E−10 | 1.286E−13 | 4.387E−14 |
| O | −1.291E−04 | −6.892E−06 | 2.106E−08 | −5.454E−10 | 1.815E−11 | −1.885E−15 | −3.490E−16 |
| P | 4.511E−06 | 1.884E−07 | −3.997E−10 | 8.660E−12 | −1.818E−13 | 1.175E−17 | 1.240E−18 |

### Sixth Embodiment

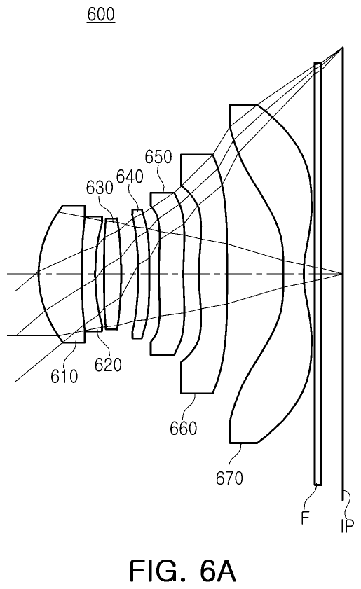

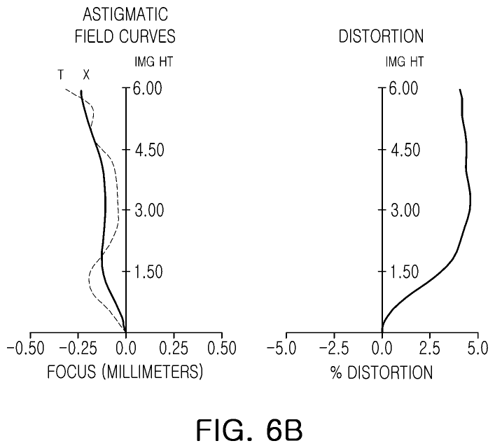

FIG. 6A is a configuration diagram illustrating an example optical imaging system according to a sixth embodiment. FIG. 6B is a graph indicating aberration properties of the example optical imaging system illustrated in FIG. 6A.

The optical imaging system 600 according to the sixth embodiment may include a first lens 610, a second lens 620, a third lens 630, a fourth lens 640, a fifth lens 650, a sixth lens 660, and a seventh lens 670. A stop may be disposed between the second lens 620 and the third lens 630.

Additionally, the optical imaging system 600 may include a filter F and an imaging plane IP disposed on an image side of the seventh lens 670. The imaging plane IP may be a portion of an image sensor, in which light is received.

The optical imaging system 600 according to the sixth embodiment may have a total focal length of 6.48 mm, an IMG HT of 6.00 mm, and a FOV of 83.40 degree (°).

Characteristics of each lens of the optical imaging system 600 according to the sixth embodiment may have values as indicated in Table 11 below.

TABLE 11

| Surface | | Radius of | Thickness/ | Refractive | Abbe | Focal |
|---|---|---|---|---|---|---|
| No. | Note | curvature | distance | index | number | length |
| S1 | First | 2.841 | 1.096 | 1.519 | 59.99 | 6.63 |
| | lens | | | | | |
| S2 | | 13.886 | 0.000 | | | |
| S3 | Second | 13.886 | 0.344 | 1.709 | 19.60 | −16.60 |
| | lens | | | | | |
| S4 | | 6.346 | 0.217 | | | |
| S5 | Third | 18.137 | 0.436 | 1.588 | 61.78 | 15.09 |
| | lens | | | | | |
| S6 | | −17.326 | 0.430 | | | |
| S7 | Fourth | −12.051 | 0.290 | 1.686 | 31.63 | −25.70 |
| | lens | | | | | |
| S8 | | −37.852 | 0.236 | | | |
| S9 | Fifth | 7.286 | 0.620 | 1.635 | 23.96 | −61.08 |
| | lens | | | | | |
| S10 | | 5.939 | 0.396 | | | |
| S11 | Sixth | 6.699 | 0.721 | 1.567 | 37.40 | 8.68 |
| | lens | | | | | |
| S12 | | −18.265 | 1.419 | | | |
| S13 | Seventh | 50.356 | 0.517 | 1.535 | 55.74 | −5.20 |
| | lens | | | | | |
| S14 | | 2.636 | 0.280 | | | |
| S15 | Filter | Infinity | 0.154 | 1.517 | 64.20 | |
| S16 | | Infinity | 0.547 | | | |
| S17 | Imaging | Infinity | | | | |
| | plane | | | | | |

According to the sixth embodiment, the first lens 610 may have positive refractive power, a first surface (an object-side surface) of the first lens 610 may be convex in a paraxial region, and a second surface (an image-side surface) of the first lens 610 may be concave in a paraxial region.

The second lens 620 may have negative refractive power, a first surface (an object-side surface) of the second lens 620 may be convex in a paraxial region, and a second surface (an image-side surface) of the second lens 620 may be concave in a paraxial region.

The third lens 630 may have positive refractive power, and both a first surface (an object-side surface) of the third lens 630 and a second surface (an image-side surface) of the third lens 630 may be convex in a paraxial region.

The fourth lens 640 may have negative refractive power, a first surface (an object-side surface) of the fourth lens 640 may be concave in a paraxial region, and a second surface (an image-side surface) of the fourth lens 640 may be convex in a paraxial region.

The fifth lens 650 may have negative refractive power, a first surface (an object-side surface) of the fifth lens 650 may be convex in a paraxial region, and a second surface (an image-side surface) of the fifth lens 650 may be concave in a paraxial region.

The sixth lens 660 may have positive refractive power, and both a first surface (an object-side surface) of the sixth lens 660 and a second surface (an image-side surface) of the sixth lens 660 may be convex in a paraxial region.

The seventh lens 670 may have negative refractive power, a first surface (an object-side surface) of the seventh lens 670 may be convex in a paraxial region, and a second surface (an image-side surface) of the seventh lens 670 may be concave in a paraxial region.

According to the sixth embodiment, the first lens 610 and the second lens 620 may be a cemented lens.

For example, a second surface (an image-side surface) of the first lens 610 and a first surface (an object-side surface) of the second lens 620 bonded to the second surface (an image-side surface) of the first lens 610 may be aspherical.

According to the sixth embodiment, at least one surface of each of the first to seventh lenses 610-670 may be aspherical.

Aspherical constants of each lens of the optical imaging system 600 according to the sixth embodiment may have values as indicated in Table 12 below.

TABLE 12

| | S1 | S2 | S3 | S4 | S5 | S6 | S7 |
|---|---|---|---|---|---|---|---|
| K | −1.563 | −0.309 | −0.309 | 11.660 | 43.108 | 98.897 | 23.650 |
| A | 2.850E−02 | 1.832E−02 | 1.832E−02 | 4.123E−02 | −4.058E−02 | −3.802E−03 | 4.989E−02 |
| B | −1.104E−01 | −3.771E−01 | −3.771E−01 | −4.111E−01 | 3.342E−0−1 | −7.972E−02 | −4.509E−01 |
| C | 3.344E−01 | 2.873E+00 | 2.873E+00 | 2.137E+00 | −1.874E+00 | −6.507E−02 | 2.081E+00 |
| D | −6.155E−01 | −1.183E+01 | −1.183E+01 | −7.211E+00 | 6.632E+00 | 4.455E−01 | −6.068E+00 |
| E | 7.428E−01 | 3.037E+01 | 3.037E+01 | 1.673E+01 | −1.581E+01 | −1.252E+00 | 1.201E+01 |
| F | −6.152E−01 | −5.236E+01 | −5.236E+01 | −2.772E+01 | 2.636E+01 | 2.070E+00 | −1.685E+01 |
| G | 3.596E−01 | 6.308E+01 | 6.308E+01 | 3.347E+01 | −3.144E+01 | −2.227E+00 | 1.713E+01 |
| H | −1.505E−01 | −5.423E+01 | −5.423E+01 | −2.970E+01 | 2.708E+01 | 1.631E+00 | −1.276E+01 |
| J | 4.524E−02 | 3.348E+01 | 3.348E+01 | 1.931E+01 | −1.684E+01 | −8.266E−01 | 6.957E+00 |
| L | −9.679E−03 | −1.474E+01 | −1.474E+01 | −9.077E+00 | 7.475E+00 | 2.899E−01 | −2.741E+00 |
| M | 1.437E−03 | 4.515E+00 | 4.515E+00 | 2.994E+00 | −2.306E+00 | −6.904E−02 | 7.590E−01 |
| N | −1.404E−04 | −9.143E−01 | −9.143E−01 | −6.560E−01 | 4.688E−01 | 1.066E−02 | −1.399E−01 |
| O | 8.128E−06 | 1.100E−01 | 1.100E−01 | 8.560E−02 | −5.641E−02 | −9.648E−04 | 1.540E−02 |
| P | −2.108E−07 | −5.960E−03 | −5.960E−03 | −5.028E−03 | 3.040E−03 | 3.911E−05 | −7.652E−04 |
| | S8 | S9 | S10 | S11 | S12 | S13 | S14 |
| K | −83.244 | −27.436 | 3.606 | −1.814 | −10.522 | 98.590 | −10.452 |
| A | −4.823E−02 | −7.655E−02 | −8.041E−02 | −2.427E−02 | 1.591E−02 | −9.847E−02 | −3.850E−02 |
| B | 9.309E−02 | 7.859E−02 | 3.898E−02 | −1.533E−02 | −2.105E−02 | 3.438E−02 | 1.611E−02 |
| C | −2.481E−01 | −1.021E−01 | −1.056E−02 | 3.354E−02 | 2.294E−02 | −7.936E−03 | −5.444E−03 |
| D | 5.584E−01 | 1.465E−01 | −1.296E−02 | −3.068E−02 | −1.522E−02 | 1.254E−03 | 1.298E−03 |
| E | −9.133E−01 | −1.944E−01 | 1.944E−02 | 1.555E−02 | 6.341E−03 | −1.326E−04 | −2.146E−04 |
| F | 1.049E+00 | 1.968E−01 | −1.344E−02 | −4.801E−03 | −1.790E−03 | 9.627E−06 | 2.480E−05 |
| G | −8.508E−01 | −1.419E−01 | 5.965E−03 | 8.898E−04 | 3.593E−04 | −5.600E−07 | −2.030E−06 |
| H | 4.919E−01 | 7.182E−02 | −1.843E−03 | −7.820E−05 | −5.250E−05 | 3.620E−08 | 1.188E−07 |
| J | −2.032E−01 | −2.544E−02 | 4.068E−04 | −4.146E−06 | 5.620E−06 | −2.638E−09 | −4.979E−09 |
| L | 5.945E−02 | 6.249E−03 | −6.399E−05 | 2.081E−06 | −4.367E−07 | 1.553E−10 | 1.479E−10 |
| M | −1.202E−02 | −1.040E−03 | 7.000E−06 | −2.696E−07 | 2.397E−08 | −6.163E−12 | −3.034E−12 |
| N | 1.596E−03 | 1.115E−04 | −5.048E−07 | 1.843E−08 | −8.803E−10 | 1.527E−13 | 4.085E−14 |
| O | −1.251E−04 | −6.931E−06 | 2.151E−08 | −6.721E−10 | 1.939E−11 | −2.137E−15 | −3.244E−16 |
| P | 4.389E−06 | 1.895E−07 | −4.094E−10 | 1.034E−11 | −1.934E−13 | 1.293E−17 | 1.150E−18 |

### Seventh Embodiment

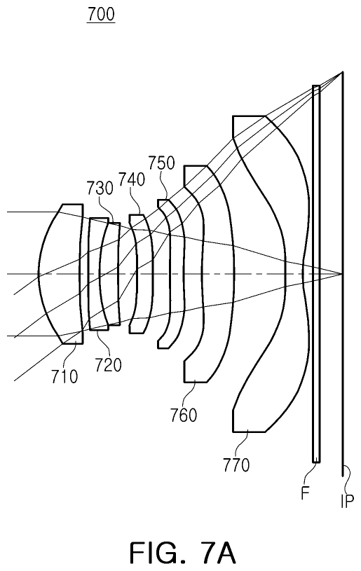

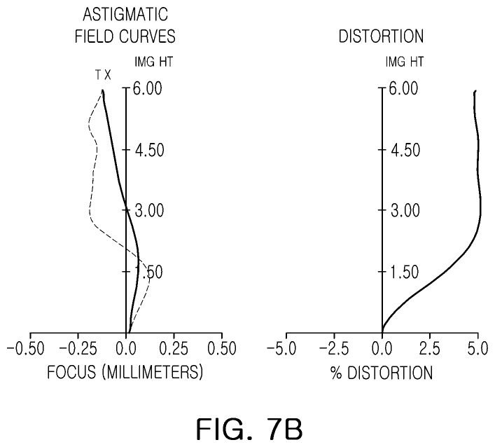

FIG. 7A is a configuration diagram illustrating an example optical imaging system according to a seventh embodiment. FIG. 7B is a graph indicating aberration properties of the example optical imaging system illustrated in FIG. 7A.

An optical imaging system 700 according to the seventh embodiment may include a first lens 710, a second lens 720, a third lens 730, a fourth lens 740, a fifth lens 750, a sixth lens 760, and a seventh lens 770. A stop may be disposed between the second lens 720 and the third lens 730.

Additionally, the optical imaging system 700 may include a filter F and an imaging plane IP disposed on an image side of the seventh lens 770. The imaging plane IP may be a portion of an image sensor, in which light is received.

The optical imaging system 700 according to the seventh embodiment may have a total focal length of 7.32 mm, an IMG HT of 6.00 mm, and a FOV of 76.13 degrees (°).

Characteristics of each lens of the optical imaging system 700 according to the seventh embodiment may have values as indicated in Table 13 below.

TABLE 13

| Surface | | Radius of | Thickness/ | Refractive | Abbe | Focal |
|---|---|---|---|---|---|---|
| No. | Note | curvature | distance | index | number | length |
| S1 | First | 3.070 | 1.171 | 1.565 | 59.95 | 7.11 |
| | lens | | | | | |
| S2 | | 11.066 | 0.244 | | | |
| S3 | Second | 23.773 | 0.326 | 1.710 | 27.38 | −8.41 |
| | lens | | | | | |
| S4 | | 4.780 | 0.000 | | | |
| S5 | Third | 4.780 | 0.522 | 1.590 | 72.91 | 10.44 |
| | lens | | | | | |
| S6 | | 20.256 | 0.531 | | | |
| S7 | Fourth | −28.992 | 0.447 | 1.702 | 24.47 | −69.14 |
| | lens | | | | | |
| S8 | | −71.375 | 0.489 | | | |
| S9 | Fifth | 8.990 | 0.386 | 1.679 | 32.61 | −61.13 |
| | lens | | | | | |
| S10 | | 7.271 | 0.520 | | | |
| S11 | Sixth | 9.191 | 0.899 | 1.567 | 37.40 | 9.13 |
| | lens | | | | | |
| S12 | | −11.594 | 1.461 | | | |
| S13 | Seventh | 63.749 | 0.497 | 1.535 | 55.74 | −6.78 |
| | lens | | | | | |
| S14 | | 3.436 | 0.297 | | | |
| S15 | Filter | Infinity | 0.163 | 1.517 | 64.20 | |
| S16 | | Infinity | 0.664 | | | |
| S17 | Imaging | Infinity | | | | |
| | plane | | | | | |

According to the seventh embodiment, the first lens 710 may have positive refractive power, a first surface (an object-side surface) of the first lens 710 may be convex in a paraxial region, and a second surface (an image-side surface) of the first lens 710 may be concave in a paraxial region.

The second lens 720 may have negative refractive power, a first surface (an object-side surface) of the second lens 720 may be convex in a paraxial region, and a second surface (an image-side surface) of the second lens 720 may be concave in a paraxial region.

The third lens 730 may have positive refractive power, a first surface (an object-side surface) of the third lens 730 may be convex in a paraxial region, and a second surface (an image-side surface) of the third lens 730 may be concave in a paraxial region.

The fourth lens 740 may have negative refractive power, a first surface (an object-side surface) of the fourth lens 740 may be concave in a paraxial region, and a second surface (an image-side surface) of the fourth lens 740 may be convex in a paraxial region.

The fifth lens 750 may have negative refractive power, a first surface (an object-side surface) of the fifth lens 750 may be convex in a paraxial region, and a second surface (an image-side surface) of the fifth lens 750 may be concave in a paraxial region.

The sixth lens 760 may have positive refractive power, and both a first surface (an object-side surface) of the sixth lens 760 and a second surface (an image-side surface) of the sixth lens 760 may be convex in a paraxial region.

The seventh lens 770 may have negative refractive power, a first surface (an object-side surface) of the seventh lens 770 may be convex in a paraxial region, and a second surface (an image-side surface) of the seventh lens 770 may be concave in a paraxial region.

According to the seventh embodiment, the second lens 720 and the third lens 730 may be a cemented lens.

For example, a second surface (an image-side surface) of the second lens 720 and a first surface (an object-side surface) of the third lens 730 bonded to the second surface (an image-side surface) of the second lens 720 may be spherical.

According to the seventh embodiment, at least one surface of each of the first to seventh lenses 710-770 may be aspherical.

Aspherical constants of each lens of the optical imaging system 700 according to the seventh embodiment may have values as indicated in Table 14 below.

TABLE 14

| | S1 | S2 | S3 | S4 | S5 | S6 | S7 |
|---|---|---|---|---|---|---|---|
| K | −1.817 | −36.789 | 19.210 | 0.000 | 0.000 | 98.996 | 98.908 |
| A | −6.482E−04 | −7.683E−03 | −3.575E−02 | 0.000E+00 | 0.000E+00 | −8.947E−02 | −2.210E−02 |
| B | 3.705E−02 | 2.802E−02 | 2.287E−01 | 0.000E+00 | 0.000E+00 | 6.391E−01 | −4.521E−02 |
| C | −9.076E−02 | −7.365E−02 | −8.783E−01 | 0.000E+00 | 0.000E+00 | −2.653E+00 | 3.060E−01 |
| D | 1.312E−01 | 1.210E−01 | 2.126E+00 | 0.000E+00 | 0.000E+00 | 6.976E+00 | −1.012E+00 |
| E | −1.239E−01 | −1.341E−01 | −3.440E+00 | 0.000E+00 | 0.000E+00 | −1.235E+01 | 2.072E+00 |
| F | 8.068E−02 | 1.036E−01 | 3.870E+00 | 0.000E+00 | 0.000E+00 | 1.528E+01 | −2.860E+00 |
| G | −3.728E−02 | −5.696E−02 | −3.102E+00 | 0.000E+00 | 0.000E+00 | −1.352E+01 | 2.765E+00 |
| H | 1.239E−02 | 2.252E−02 | 1.793E+00 | 0.000E+00 | 0.000E+00 | 8.666E+00 | −1.907E+00 |
| J | −2.970E−03 | −6.417E−03 | −7.490E−01 | 0.000E+00 | 0.000E+00 | −4.023E+00 | 9.424E−01 |
| L | 5.072E−04 | 1.305E−03 | 2.237E−01 | 0.000E+00 | 0.000E+00 | 1.339E+00 | −3.306E−01 |
| M | −6.006E−05 | −1.846E−04 | −4.652E−02 | 0.000E+00 | 0.000E+00 | −3.112E−01 | 8.024E−02 |
| N | 4.674E−06 | 1.726E−05 | 6.396E−03 | 0.000E+00 | 0.000E+00 | 4.792E−02 | −1.280E−02 |
| O | −2.143E−07 | −9.586E−07 | −5.220E−04 | 0.000E+00 | 0.000E+00 | −4.394E−03 | 1.205E−03 |
| P | 4.374E−09 | 2.393E−08 | 1.914E−05 | 0.000E+00 | 0.000E+00 | 1.815E−04 | −5.070E−05 |
| | S8 | S9 | S10 | S11 | S12 | S13 | S14 |
| K | −61.386 | −45.041 | 2.124 | 3.452 | 8.868 | 89.727 | −11.661 |
| A | −7.758E−03 | −5.407E−02 | −8.308E−02 | −2.349E−02 | −1.893E−03 | −8.279E−02 | −3.057E−02 |
| B | −7.653E−02 | 3.488E−02 | 8.196E−02 | 7.309E−03 | −6.121E−06 | 3.294E−02 | 1.104E−02 |
| C | 2.076E−01 | −9.783E−03 | −9.859E−02 | −7.479E−04 | 5.029E−03 | −1.018E−02 | −3.170E−03 |
| D | −3.306E−01 | −3.234E−02 | 9.214E−02 | −5.981E−04 | −4.180E−03 | 2.328E−03 | 6.381E−04 |
| E | 3.287E−01 | 5.664E−02 | −6.643E−02 | −8.014E−04 | 1.667E−03 | −3.785E−04 | −9.041E−05 |
| F | −2.031E−01 | −5.001E−02 | 3.638E−02 | 9.387E−04 | −4.122E−04 | 4.395E−05 | 9.155E−06 |
| G | 6.812E−02 | 2.895E−02 | −1.486E−02 | −4.253E−04 | 6.926E−05 | −3.692E−06 | −6.696E−07 |
| H | −1.308E−03 | −1.181E−02 | 4.464E−03 | 1.122E−04 | −8.235E−06 | 2.263E−07 | 3.552E−08 |
| J | −1.022E−02 | 3.475E−03 | −9.750E−04 | −1.913E−05 | 7.036E−07 | −1.013E−08 | −1.361E−09 |
| L | 5.137E−03 | −7.356E−04 | 1.522E−04 | 2.179E−06 | −4.310E−08 | 3.271E−10 | 3.718E−11 |
| M | −1.331E−03 | 1.095E−04 | −1.647E−05 | −1.649E−07 | 1.853E−09 | −7.427E−12 | −7.043E−13 |
| N | 2.023E−04 | −1.086E−05 | 1.172E−06 | 7.962E−09 | −5.320E−11 | 1.125E−13 | 8.775E−15 |
| O | −1.712E−05 | 6.452E−07 | −4.918E−08 | −2.222E−10 | 9.179E−13 | −1.019E−15 | −6.457E−17 |
| P | 6.262E−07 | −1.732E−08 | 9.213E−10 | 2.728E−12 | −7.203E−15 | 4.183E−18 | 2.124E−19 |

### Eighth Embodiment

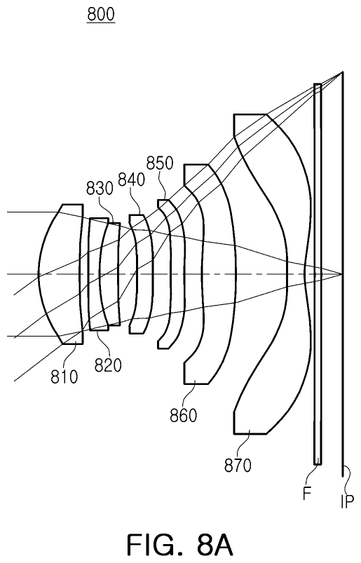

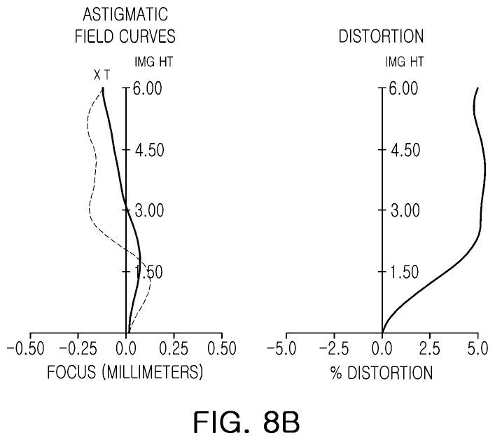

FIG. 8A is a configuration diagram illustrating an example optical imaging system according to an eighth embodiment. FIG. 8B is a graph indicating aberration properties of the example optical imaging system illustrated in FIG. 8A.

An optical imaging system 800 according to the eighth embodiment may include a first lens 810, a second lens 820, a third lens 830, a fourth lens 840, a fifth lens 850, a sixth lens 860, and a seventh lens 870. A stop may be disposed between the second lens 820 and the third lens 830.

Additionally, the optical imaging system 800 may include a filter F and an imaging plane IP disposed on an image side of the seventh lens 870. The imaging plane IP may be a portion of an image sensor, in which light is received.

The optical imaging system 800 according to the eighth embodiment may have a total focal length of 7.27 mm, an IMG HT of 6.00 mm, and a FOV of 76.50) degrees (°.

Characteristics of each lens of the optical imaging system 800 according to the eighth embodiment may have values as indicated in Table 15 below.

TABLE 15

| Surface | | Radius of | Thickness/ | Refractive | Abbe | Focal |
|---|---|---|---|---|---|---|
| No. | Note | curvature | distance | index | number | length |
| S1 | First | 3.070 | 1.173 | 1.568 | 56.55 | 7.08 |
| | lens | | | | | |
| S2 | | 11.022 | 0.243 | | | |
| S3 | Second | 23.492 | 0.324 | 1.707 | 24.55 | −8.11 |
| | lens | | | | | |
| S4 | | 4.619 | 0.000 | | | |
| S5 | Third | 4.619 | 0.520 | 1.590 | 55.55 | 9.97 |
| | lens | | | | | |
| S6 | | 20.222 | 0.533 | | | |
| S7 | Fourth | −29.152 | 0.450 | 1.701 | 26.92 | −69.14 |
| | lens | | | | | |
| S8 | | −72.708 | 0.488 | | | |
| S9 | Fifth | 9.030 | 0.383 | 1.676 | 33.04 | −62.25 |
| | lens | | | | | |
| S10 | | 7.315 | 0.522 | | | |
| S11 | Sixth | 9.187 | 0.935 | 1.567 | 37.40 | 9.14 |
| | lens | | | | | |
| S12 | | −11.630 | 1.465 | | | |
| S13 | Seventh | 63.998 | 0.480 | 1.535 | 55.74 | −6.69 |
| | lens | | | | | |
| S14 | | 3.395 | 0.297 | | | |
| S15 | Filter | Infinity | 0.163 | 1.517 | 64.20 | |
| S16 | | Infinity | 0.617 | | | |
| S17 | Imaging | Infinity | | | | |
| | plane | | | | | |

According to the eighth embodiment, the eighth lens 810 may have positive refractive power, a first surface (an object-side surface) of the first lens 810 may be convex in a paraxial region, and a second surface (an image-side surface) of the first lens 810 may be concave in a paraxial region.

The second lens 820 may have negative refractive power, a first surface (an object-side surface) of the second lens 820 may be convex in a paraxial region, and a second surface (an image-side surface) of the second lens 820 may be concave in a paraxial region.

The third lens 830 may have positive refractive power, a first surface (an object-side surface) of the third lens 830 may be convex in a paraxial region, and a second surface (an image-side surface) of the third lens 830 may be concave in a paraxial region.

The fourth lens 840 may have negative refractive power, a first surface (an object-side surface) of the fourth lens 840 may be concave in a paraxial region, and a second surface (an image-side surface) of the fourth lens 840 may be convex in a paraxial region.

The fifth lens 850 may have negative refractive power, a first surface (an object-side surface) of the fifth lens 850 may be convex in a paraxial region, and a second surface (an image-side surface) of the fifth lens 850 may be concave in a paraxial region.

The sixth lens 860 may have positive refractive power, and both a first surface (an object-side surface) of the sixth lens 860 and a second surface (an image-side surface) of the sixth lens 860 may be convex in a paraxial region.

The seventh lens 870 may have negative refractive power, a first surface (an object-side surface) of the seventh lens 870 may be convex in a paraxial region, and a second surface (an image-side surface) of the seventh lens 870 may be concave in a paraxial region.

According to the eighth embodiment, the second lens 820 and the third lens 830 may be a cemented lens.

For example, a second surface (an image-side surface) of the second lens 820 and a first surface (an object-side surface) of the third lens 830 bonded to the second surface (an image-side surface) of the second lens 820 may be aspherical.

According to the eighth embodiment, at least one surface of each of the first to seventh lenses 810-870 may be aspherical.

Aspherical constants of each lens of the optical imaging system 800 according to the eighth embodiment may have values as indicated in Table 16 below.

TABLE 16

| | S1 | S2 | S3 | S4 | S5 | S6 | S7 |
|---|---|---|---|---|---|---|---|
| K | −1.816 | −37.685 | 18.641 | 0.029 | 0.029 | 99.049 | 98.756 |
| A | −9.617E−04 | −7.591E−03 | −3.314E−02 | 7.646E−04 | 7.646E−04 | −8.765E−02 | −2.063E−02 |
| B | 3.891E−02 | 2.669E−02 | 2.030E−01 | −6.949E−03 | −6.949E−03 | 6.273E−01 | −6.158E−02 |
| C | −9.574E−02 | −6.731E−02 | −7.587E−01 | 3.451E−02 | 3.451E−02 | −2.617E+00 | 3.940E−01 |
| D | 1.387E−01 | 1.052E−01 | 1.801E+00 | −1.422E−01 | −1.422E−01 | 6.926E+00 | −1.287E+00 |
| E | −1.311E−01 | −1.108E−01 | −2.875E+00 | 4.449E−01 | 4.449E−01 | −1.235E+01 | 2.621E+00 |
| F | 8.531E−02 | 8.134E−02 | 3.210E+00 | −9.789E−01 | −9.789E−01 | 1.540E+01 | −3.599E+00 |
| G | −3.933E−02 | −4.244E−02 | −2.565E+00 | 1.502E+00 | 1.502E+00 | −1.375E+01 | 3.459E+00 |
| H | 1.304E−02 | 1.592E−02 | 1.483E+00 | −1.625E+00 | −1.625E+00 | 8.892E+00 | −2.369E+00 |
| J | −3.113E−03 | −4.302E−03 | −6.207E−01 | 1.247E+00 | 1.247E+00 | −4.166E+00 | 1.162E+00 |
| L | 5.293E−04 | 8.289E−04 | 1.861E−01 | −6.755E−01 | −6.755E−01 | 1.399E+00 | −4.043E−01 |
| M | −6.236E−05 | −1.110E−04 | −3.889E−02 | 2.529E−01 | 2.529E−01 | −3.281E−01 | 9.739E−02 |
| N | 4.824E−06 | 9.824E−06 | 5.376E−03 | −6.224E−02 | −6.224E−02 | 5.099E−02 | −1.542E−02 |
| O | −2.197E−07 | −5.157E−07 | −4.413E−04 | 9.065E−03 | 9.065E−03 | −4.717E−03 | 1.442E−03 |
| P | 4.447E−09 | 1.216E−08 | 1.627E−05 | −5.920E−04 | −5.920E−04 | 1.965E−04 | −6.029E−05 |
| | S8 | S9 | S10 | S11 | S12 | S13 | S14 |
| K | 15.276 | −45.111 | 2.395 | 3.600 | 8.916 | 89.258 | −11.221 |
| A | −6.930E−03 | −5.536E−02 | −8.476E−02 | −2.700E−02 | −1.851E−03 | −8.306E−02 | −3.256E−02 |
| B | −8.112E−02 | 4.208E−02 | 8.914E−02 | 1.609E−02 | 5.123E−04 | 3.362E−02 | 1.311E−02 |
| C | 2.161E−01 | −2.769E−02 | −1.116E−01 | −1.131E−02 | 4.451E−03 | −1.083E−02 | −4.022E−03 |
| D | −3.316E−01 | −6.521E−03 | 1.064E−01 | 7.184E−03 | −3.885E−03 | 2.598E−03 | 8.249E−04 |
| E | 3.072E−01 | 3.240E−02 | −7.670E−02 | −4.593E−03 | 1.576E−03 | −4.413E−04 | −1.156E−04 |
| F | −1.618E−01 | −3.418E−02 | 4.146E−02 | 2.212E−03 | −3.944E−04 | 5.323E−05 | 1.143E−05 |
| G | 2.721E−02 | 2.147E−02 | −1.664E−02 | −7.267E−04 | 6.709E−05 | −4.620E−06 | −8.133E−07 |
| H | 2.435E−02 | −9.198E−03 | 4.917E−03 | 1.632E−04 | −8.088E−06 | 2.913E−07 | 4.202E−08 |
| J | −2.103E−02 | 2.798E−03 | −1.059E−03 | −2.530E−05 | 7.022E−07 | −1.335E−08 | −1.573E−09 |
| L | 8.248E−03 | −6.072E−04 | 1.632E−04 | 2.706E−06 | −4.379E−08 | 4.400E−10 | 4.212E−11 |
| M | −1.936E−03 | 9.212E−05 | −1.750E−05 | −1.959E−07 | 1.920E−09 | −1.016E−11 | −7.842E−13 |
| N | 2.781E−04 | −9.294E−06 | 1.235E−06 | 9.158E−09 | −5.627E−11 | 1.561E−13 | 9.628E−15 |
| O | −2.268E−05 | 5.600E−07 | −5.149E−08 | −2.493E−10 | 9.916E−13 | −1.431E−15 | −6.996E−17 |
| P | 8.065E−07 | −1.523E−08 | 9.592E−10 | 3.000E−12 | −7.946E−15 | 5.930E−18 | 2.276E−19 |

Lastly, conditional expression data according to embodiments may have values as indicated in Table 17 below.

TABLE 17

| Conditional | Embodi- | Embodi- | Embodi- | Embodi- |
|---|---|---|---|---|
| expression | ment 1 | ment 2 | ment 3 | ment 4 |
| \| fa/Va − fb/Vb \| | 0.884 | 0.870 | 0.392 | 0.443 |
| f1/f | 1.027 | 1.022 | 0.973 | 0.975 |
| f2/f | −2.619 | −2.562 | −1.151 | −1.116 |
| f3/f | 2.329 | 2.329 | 1.428 | 1.372 |
| f4/f | −3.963 | −3.966 | −9.453 | −9.513 |
| \| f5/f \| | 9.380 | 9.426 | 8.357 | 8.565 |
| f6/f | 1.339 | 1.340 | 1.248 | 1.258 |
| f7/f | −0.792 | −0.801 | −0.928 | −0.921 |
| TTL/f | 1.186 | 1.190 | 1.178 | 1.182 |
| BFL/f | 0.151 | 0.152 | 0.154 | 0.148 |
| TTL/(2*IMG HT) | 0.583 | 0.584 | 0.624 | 0.623 |
| f/EPD | 1.988 | 1.987 | 1.986 | 1.986 |
| Conditional | Embodi- | Embodi- | Embodi- | Embodi- |
| expression | ment 5 | ment 6 | ment 7 | ment 8 |
| \| fa/Va − fb/Vb \| | 0.972 | 0.957 | 0.450 | 0.510 |
| f1/f | 1.028 | 1.023 | 0.971 | 0.974 |
| f2/f | −2.618 | −2.562 | −1.149 | −1.116 |
| f3/f | 2.328 | 2.329 | 1.426 | 1.371 |
| f4/f | −3.961 | −3.966 | −9.445 | −9.510 |
| \| f5/f \| | 9.379 | 9.426 | 8.351 | 8.563 |
| f6/f | 1.339 | 1.340 | 1.247 | 1.257 |
| f7/f | −0.792 | −0.802 | −0.926 | −0.920 |
| TTL/f | 1.186 | 1.189 | 1.177 | 1.182 |
| BFL/f | 0.151 | 0.151 | 0.154 | 0.148 |
| TTL/(2*IMG HT) | 0.642 | 0.642 | 0.718 | 0.716 |
| f/EPD | 1.988 | 1.988 | 1.988 | 1.987 |

According to the aforementioned embodiments, by reducing the total optical length and improving chromatic aberration, the optical imaging system may obtain a high-resolution image.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical imaging system, comprising:
a first lens having positive refractive power, a second lens having negative refractive power, a third lens having positive refractive power, a fourth lens having negative refractive power, a fifth lens having refractive power, a sixth lens having positive refractive power, and a seventh lens having negative refractive power,
wherein the first lens to the seventh lens are disposed in order from an object side,
wherein the first lens to the seventh lens include a cemented lens that is formed by bonding adjacent surfaces of two lenses, disposed adjacently, to each other, and
wherein the two lenses that form the cemented lens have opposite refractive powers.

2. The optical imaging system of claim 1, wherein the first lens and the second lens or the second lens and the third lens are provided as the cemented lens.

3. The optical imaging system of claim 1, wherein the cemented lens satisfies a conditional expression:
$$0 \leq \vert fa / Va - fb / Vb \vert < 2 ,$$
where fa and Va are respectively a focal length and an Abbe number of a lens disposed on an object side among the lenses cemented to each other, and fb and Vb are respectively a focal length and an Abbe number of a lens disposed on an image side among the two lenses cemented to each other.

4. The optical imaging system of claim 1, wherein the third lens has a convex object-side surface in a paraxial region.

5. The optical imaging system of claim 1, wherein the fourth lens has a concave object-side surface in a paraxial region.

6. The optical imaging system of claim 1, wherein both an object-side surface of the sixth lens and an image-side surface of the sixth lens are convex in a paraxial region.

7. The optical imaging system of claim 1, wherein the seventh lens has a convex object-side surface in a paraxial region.

8. The optical imaging system of claim 1, wherein a conditional expression:
1.0<TTL/f<1.3, is satisfied,
where TTL is a distance from an object-side surface of the first lens to an image plane on an optical axis, and f is a total focal length of the optical imaging system.

9. The optical imaging system of claim 1, wherein the fifth lens has negative refractive power.

10. An optical imaging system, comprising:
a first lens, a second lens, a third lens having positive refractive power, a fourth lens having negative refractive power and a convex object-side surface, a fifth lens having refractive power, a sixth lens having positive refractive power, and a seventh lens having negative refractive power,
wherein the first lens to the seventh lens are disposed in order from an object side,
wherein a conditional expression:
0.5<TTL/(2*IMG HT)<0.8, is satisfied,
where TTL is a distance from an object-side surface of the first lens to an image plane on an optical axis, and IMG HT is half a diagonal length of the image plane.

11. The optical imaging system of claim 10, wherein a conditional expression:
5<|f5/f|<10, is satisfied,
where f5 is a focal length of the fifth lens, and f is a total focal length of the optical imaging system.

12. The optical imaging system of claim 10, wherein a conditional expression:
0.5<f6/f<3, is satisfied,
where f6 is a focal length of the sixth lens, and f is a total focal length of the optical imaging system.

13. The optical imaging system of claim 10, wherein a conditional expression:
1<f3/f<3, is satisfied,
where f3 is a focal length of the third lens, and f is a total focal length of the optical imaging system.

14. The optical imaging system of claim 10, wherein the third lens has a convex object-side surface in a paraxial region.

15. The optical imaging system of claim 10, wherein an object-side surface of the second lens is bonded to an image-side surface of the first lens, or an image-side surface of the second lens is bonded to an object-side surface of the third lens.

16. The optical imaging system of claim 10, wherein the first lens has positive refractive power, and the second lens has negative refractive power.

17. An optical imaging system, comprising:
a first lens, a second lens, a third lens having positive refractive power, a fourth lens having negative refractive power and a convex object-side surface, a fifth lens having refractive power, a sixth lens having positive refractive power, and a seventh lens having negative refractive power,
wherein the first lens to the seventh lens are disposed in order from an object side,
wherein a conditional expression:
−10<f4/f<−1, is satisfied,
where f4 is a focal length of the fourth lens, and f is a total focal length of the optical imaging system.
